(19) United States
(12) Patent Application Publication
(10) Pub. No.: US 2019/0064071 A1
(43) Pub. Date: Feb. 28, 2019

(54) PLASMONIC NANOCAVITY ARRAY SENSORS FOR ANALYTE DETECTION ENHANCEMENT AND METHODS FOR MAKING AND USING OF THE SAME

(71) Applicant: THE TRUSTEES OF PRINCETON UNIVERSITY, Princeton, NJ (US)

(72) Inventors: Stephen Y. Chou, Princeton, NJ (US); Hao Chen, Princeton, NJ (US)

(21) Appl. No.: 16/009,140

(22) Filed: Jun. 14, 2018

Related U.S. Application Data
(63) Continuation of application No. 14/852,412, filed on Sep. 11, 2015, now abandoned.
Application No. 14/852,412 is a continuation of application No. PCT/US2014/030108, filed on Mar. 16, 2014.
Application No. 14/852,412 is a continuation-in-part of application No. 13/838,600, filed on Mar. 15, 2013.
Application No. 13/838,600 is a continuation-in-part of application No. 13/699,270, filed on Jun. 13, 2013, now Pat. No. 9,182,338.
Application No. 14/852,412 is a continuation-in-part of application No. 13/699,270, filed on Jun. 13, 2013, now Pat. No. 9,182,338.
(60) Provisional application No. 61/801,933, filed on Mar. 15, 2013.
(60) Provisional application No. 61/794,317, filed on Mar. 15, 2013.
(60) Provisional application No. 61/622,226, filed on Apr. 10, 2012.
(60) Provisional application No. 61/347,178, filed on May 21, 2010.
(60) Provisional application No. 61/347,178, filed on May 21, 2010.

(51) Int. Cl. G01N 21/64; B82Y 15/00; B82Y 20/00

(52) U.S. Cl. CPC G01N 21/6486; G01N 21/6428; G01N 2201/06113; B82Y 15/00; B82Y 20/00; G01N 21/648

(57) ABSTRACT

This disclosure provides, among other things, a nanosensor for sensing an analyte. In some embodiments the nanosensor comprises (a) a substrate; (b) a signal amplification layer comprising: (i) a substantially continuous metallic backplane on the substrate; (ii) one or a plurality of pillars extending from the metallic backplane or from the substrate through holes in the backplane; and (iii) a metallic disk on top of the pillar, wherein at least one portion of the edge of the disk is separated from the metallic backplane; and (c) a capture agent that specifically binds to the analyte, wherein the capture agent is linked to the surface of the signal amplification layer; wherein the nanosensor amplifies a light signal from an analyte, when the analyte is bound to the capture agent. Methods for fabricating the nanosensor and methods for using the nanosensor are also provided.

### CROSS-REFERENCING

This application is a continuation-in-part of U.S. application Ser. No. 13/838,600, filed Mar. 15, 2013 (NSNR-003), which application claims the benefit of U.S. provisional application Ser. No. 61/622,226 filed on Apr. 10, 2012, and is a continuation-in-part of U.S. patent application Ser. No. 13/699,270, filed on Jun. 13, 2013, which application is a § 371 filing of US2011/037455, filed on May 20, 2011, and claims the benefit of U.S. provisional application Ser. No. 61/347,178, filed on May 21, 2010;

This application is also a continuation-in-part of U.S. application Ser. No. 13/699,270, filed Jun. 13, 2013 (NSNR-001), which application is a § 371 filing of international application serial no. US2011/037455, filed on May 20, 2011, which application claims the benefit of U.S. Provisional Patent Application Ser. No. 61/347,178 filed on May 21, 2010; and

This application is also claims the benefit of: provisional application Ser. No. 61/801,424, filed Mar. 15, 2013 (NSNR-004PRV), provisional application Ser. No. 61/801,096, filed Mar. 15, 2013 (NSNR-005PRV), provisional application Ser. No. 61/800,915, filed Mar. 15, 2013 (NSNR-006PRV), provisional application Ser. No. 61/793,092, filed Mar. 15, 2013 (NSNR-008PRV), provisional Application Ser. No. 61/801,933, filed Mar. 15, 2013 (NSNR-009PRV), provisional Application Ser. No. 61/794,317, filed Mar. 15, 2013 (NSNR-010PRV), provisional application Ser. No. 61/802,020, filed Mar. 15, 2013 (NSNR-011PRV) and provisional application Ser. No. 61/802,223, filed Mar. 15, 2013 (NSNR-012PRV), all of which applications are incorporated by reference herein for all purposes.

### STATEMENT REGARDING FEDERALLY SPONSORED RESEARCH

This invention was made with government support under Grant No. FA9550-08-1-0222 awarded by the Defense Advanced Research Project Agency (DARPA). The United States government has certain rights in the invention.

### BACKGROUND

The invention is related to the devices, systems, and methods that can improve the property of an assay in sensing an analyte, particularly sensing sensitivity, and their making and use. The invention is related to the assays that have a signal amplification layer (SAL) that immobilizes the capture agent and amplifies the captured analytes. The invention is related to significantly increase such amplification. The amplification layer can increase the assay sensitivity without an amplification of the number of molecules. The invention is related to the methods that can make such assays with high throughput and low cost. The analyte include proteins, peptides, DNA, RNA, nucleic acid, small molecules, cells, nanoparticles with different shapes. The targeted analyte can be either in a solution or in air or gas phase. The sensing includes the detection of the existence, quantification of the concentration, and determination of the states of the targeted analyte.

There are great needs to develop the assays devices that can significantly enhance the analyte detection, and the fabrication methods that can significantly reduce the cost of such devices.

The invention overcome the shortcoming of prior arts and offer higher analyte sensing sensitivity.

### SUMMARY

The following brief summary is not intended to include all features and aspects of the present invention, nor does it imply that the invention must include all features and aspects discussed in this summary.

This invention is related to, among other things, a nanosensor for sensing an analyte and fabrication of such nanosensors. The analyte include proteins, peptides, DNA, RNA, nucleic acid, small molecules, cells, nanoparticles with different shapes The targeted analyte can be either in a solution or in air or gas phase. The sensing includes the detection of the existence, quantification of the concentration, and determination of the states of the targeted analyte.

The invention is related to the assays that have a signal amplification layer (SAL) that immobilizes the capture agent and amplifies the captured analytes. The invention is related to significantly increase such amplification. The amplification layer can increase the assay sensitivity without an amplification of the number of molecules. The invention is related to the methods that can make such assays with high throughput and low cost. The analyte include proteins, peptides, DNA, RNA, nucleic acid, small molecules, cells, nanoparticles with different shapes. The targeted analyte can be either in a solution or in air or gas phase. The sensing includes light absorption, light scattering, light radiation, Raman scattering, chromaticity, luminescence that includes fluorescence, electroluminescence, chemiluminescence, and electrochemiluminescence. The sensing property includes the sensing signal intensity, sensing signal spectrum, limit of detection, detection dynamic range, and signal variation reduction (smaller error bar) of the sensing. The sensing includes the detection of the existence, quantification of the concentration, and determination of the states of the targeted analyte. The invention can be used in the sensing in vitro, or in vivo.

### BRIEF DESCRIPTION OF THE DRAWINGS

The skilled artisan will understand that the drawings, described below, are for illustration purposes only. The drawings are not intended to limit the scope of the present teachings in any way. Some of the drawings are not in scale.

FIG. 1 A “box-diagram” illustrates the relative position of each “layer”. The diagram is not in scale, nor reflects the fact some “layers” of discrete molecules. The molecular adhesion layer is optional.

FIG. 2 schematically illustrates some of the components of an exemplary system.

FIG. 3. Schematic of Disk-on-Pillar (DoP) structure (400). (a) overview of general structure. (b) Cross-section of one embodiment where the back metallic film is around and next to the pillars which are dielectric or semiconductor. (c, d, e) cross-section of another embodiment, where the metallic film is a sheet of film go under the disk, but the pillars have different lateral dimension than that of the disks.

FIG. 4. Electromagnetic simulation of DoP with the pillar smaller than the disk, showing the high amplification regions are in the metallic sharp edges and the small gaps between two metallic materials. The dash line indicates the surface that are accessible by the capture agent and hence the analytes.

FIG. 5. Schematic of PCCM with random metallic nanoislands (530) locate on top of a continuous dielectric film (521) instead of pillars, on a sheet of metal film (550).

FIG. 6 Schematic of disk-coupled dots-on-pillar antenna array (D2PA) plate with a molecular linking layer. (A) Overview of D2PA plate without an immunoassay. (b) Cross-section after coating the molecular linking layer (also termed “molecular admission layer”) (160). (c) Before and after coating the molecular linking layer.

FIG. 7 schematically illustrates an exemplary antibody detection assay.

FIG. 8 schematically illustrates an exemplary nucleic acid detection assay.

FIG. 9 schematically illustrates another embodiment nucleic acid detection assay.

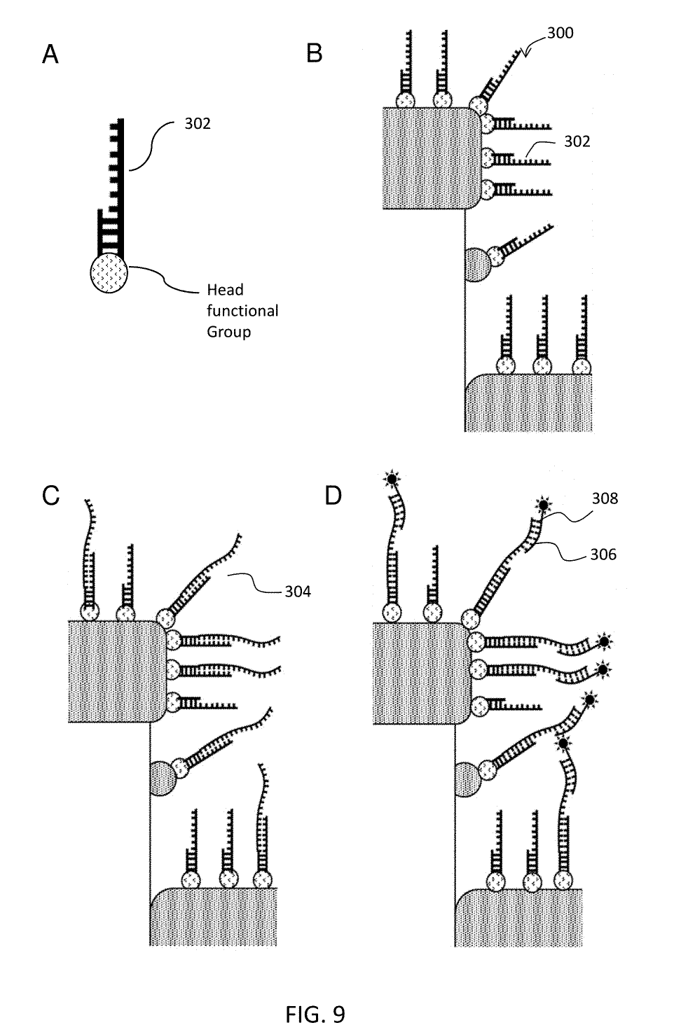

FIG. 10 shows the exemplary fabrication method-1.

FIG. 11 shows the exemplary fabrication method-2.

FIG. 12 shows the exemplary fabrication method-3.

FIG. 13 Fabrication result of one embodiment of DoP structure. (a) parameter used in the fabrication, including disk size s_{disk}, disk height t_{Au}, and pillar height t_{oxide}. (b) top-view and (c) tilted-view of fabricated DoP structure.

FIG. 14 Reflection spectrum of a DoP sample, whose resonance peak has been tune to 800 nm and peak width of 80 nm. By deliberately tuning disk and pillar size, resonance peak at 650 nm-850 nm can be achieved.

FIG. 15 Immunoassay test on glass (blue curve, reference, magnified by 1000 times), DoP (green curve) and DoP with pillar shrinking (red curve). Enhancement factor from DoP with pillar shrinking can be as high as 6500 on average.

FIG. 16 schematic of flow chart for fabrication of PCCM.

FIG. 17 SEM picture of nano-islands (PCCM) on continuous dielectric film. (a) top-view; (b) tilted-view.

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### Definitions

Before describing exemplary embodiments in greater detail, the following definitions are set forth to illustrate and define the meaning and scope of the terms used in the description.

The term “molecular adhesion layer” refers to a layer or multilayer of molecules of defined thickness that comprises an inner surface that is attached to the D2PA nanodevice and an outer (exterior) surface can be bound to capture agents.

The term “capture agent-reactive group” refers to a moiety of chemical function in a molecule that is reactive with capture agents, i.e., can react with a moiety (e.g., a hydroxyl, sulfhydryl, carboxy or amine group) in a capture agent to produce a stable strong, e.g., covalent bond.

The term “capture agent” as used herein refers to an agent that binds to a target analyte through an interaction that is sufficient to permit the agent to bind and concentrate the target molecule from a heterogeneous mixture of different molecules. The binding interaction is typically mediated by an affinity region of the capture agent. Typical capture agents include any moiety that can specifically bind to a target analyte. Certain capture agents specifically bind a target molecule with a dissociation constant (K_{D}) of less than about 10⁻⁶ M (e.g., less than about 10⁻⁷M, less than about 10⁻⁸M, less than about 10⁻⁹M, less than about 10⁻¹⁰ M, less than about 10⁻¹¹ M, less than about 10⁻¹² M, to as low as 10⁻¹⁶ M) without significantly binding to other molecules. Exemplary capture agents include proteins (e.g., antibodies), and nucleic acids (e.g., oligonucleotides, DNA, RNA including aptamers).

The terms “specific binding” and “selective binding” refer to the ability of a capture agent to preferentially bind to a particular target molecule that is present in a heterogeneous mixture of different target molecule. A specific or selective binding interaction will discriminate between desirable (e.g., active) and undesirable (e.g., inactive) target molecules in a sample, typically more than about 10 to 100-fold or more (e.g., more than about 1000- or 10,000-fold).

The term “protein” refers to a polymeric form of amino acids of any length, i.e. greater than 2 amino acids, greater than about 5 amino acids, greater than about 10 amino acids, greater than about 20 amino acids, greater than about 50 amino acids, greater than about 100 amino acids, greater than about 200 amino acids, greater than about 500 amino acids, greater than about 1000 amino acids, greater than about 2000 amino acids, usually not greater than about 10,000 amino acids, which can include coded and non-coded amino acids, chemically or biochemically modified or derivatized amino acids, and polypeptides having modified peptide backbones. The term includes fusion proteins, including, but not limited to, fusion proteins with a heterologous amino acid sequence, fusions with heterologous and homologous leader sequences, with or without N-terminal methionine residues; immunologically tagged proteins; fusion proteins with detectable fusion partners, e.g., fusion proteins including as a fusion partner a fluorescent protein, β-galactosidase, luciferase, etc.; and the like. Also included by these terms are polypeptides that are post-translationally modified in a cell, e.g., glycosylated, cleaved, secreted, prenylated, carboxylated, phosphorylated, etc., and polypeptides with secondary or tertiary structure, and polypeptides that are strongly bound, e.g., covalently or non-covalently, to other moieties, e.g., other polypeptides, atoms, cofactors, etc.

The term “antibody” is intended to refer to an immunoglobulin or any fragment thereof, including single chain antibodies that are capable of antigen binding and phage display antibodies).

The term “nucleic acid” and “polynucleotide” are used interchangeably herein to describe a polymer of any length composed of nucleotides, e.g., deoxyribonucleotides or ribonucleotides, or compounds produced synthetically (e.g., PNA as described in U.S. Pat. No. 5,948,902 and the references cited therein) which can hybridize with naturally occurring nucleic acids in a sequence specific manner analogous to that of two naturally occurring nucleic acids, e.g., can participate in Watson-Crick base pairing interactions.

The term “complementary” as used herein refers to a nucleotide sequence that base-pairs by hydrogen bonds to a target nucleic acid of interest. In the canonical Watson-Crick base pairing, adenine (A) forms a base pair with thymine (T), as does guanine (G) with cytosine (C) in DNA. In RNA, thymine is replaced by uracil (U). As such, A is complementary to T and G is complementary to C. Typically, “complementary” refers to a nucleotide sequence that is fully complementary to a target of interest such that every nucleotide in the sequence is complementary to every nucleotide in the target nucleic acid in the corresponding positions. When a nucleotide sequence is not fully complementary (100% complementary) to a non-target sequence but still may base pair to the non-target sequence due to complementarity of certain stretches of nucleotide sequence to the non-target sequence, percent complementarily may be calculated to assess the possibility of a non-specific (off-target) binding. In general, a complementary of 50% or less does not lead to non-specific binding. In addition, a complementary of 70% or less may not lead to non-specific binding under stringent hybridization conditions.

The terms “ribonucleic acid” and “RNA” as used herein mean a polymer composed of ribonucleotides.

The terms “deoxyribonucleic acid” and “DNA” as used herein mean a polymer composed of deoxyribonucleotides.

The term “oligonucleotide” as used herein denotes single stranded nucleotide multimers of from about 10 to 200 nucleotides and up to 300 nucleotides in length, or longer, e.g., up to 500 nt in length or longer. Oligonucleotides may be synthetic and, in certain embodiments, are less than 300 nucleotides in length.

The term “attaching” as used herein refers to the strong, e.g, covalent or non-covalent, bond joining of one molecule to another.

The term “surface attached” as used herein refers to a molecule that is strongly attached to a surface.

The term “sample” as used herein relates to a material or mixture of materials containing one or more analytes of interest. In particular embodiments, the sample may be obtained from a biological sample such as cells, tissues, bodily fluids, and stool. Bodily fluids of interest include but are not limited to, amniotic fluid, aqueous humour, vitreous humour, blood (e.g., whole blood, fractionated blood, plasma, serum, etc.), breast milk, cerebrospinal fluid (CSF), cerumen (earwax), chyle, chime, endolymph, perilymph, feces, gastric acid, gastric juice, lymph, mucus (including nasal drainage and phlegm), pericardial fluid, peritoneal fluid, pleural fluid, pus, rheum, saliva, sebum (skin oil), semen, sputum, sweat, synovial fluid, tears, vomit, urine and exhaled condensate. In particular embodiments, a sample may be obtained from a subject, e.g., a human, and it may be processed prior to use in the subject assay. For example, prior to analysis, the protein/nucleic acid may be extracted from a tissue sample prior to use, methods for which are known. In particular embodiments, the sample may be a clinical sample, e.g., a sample collected from a patient.

The term “analyte” refers to a molecule (e.g., a protein, nucleic acid, or other molecule) that can be bound by a capture agent and detected.

The term “assaying” refers to testing a sample to detect the presence and/or abundance of an analyte.

As used herein, the terms “determining,” “measuring,” and “assessing,” and “assaying” are used interchangeably and include both quantitative and qualitative determinations.

As used herein, the term “light-emitting label” refers to a label that can emit light when under an external excitation. This can be luminescence. Fluorescent labels (which include dye molecules or quantum dots), and luminescent labels (e.g., electro- or chemi-luminescent labels) are types of light-emitting label. The external excitation is light (photons) for fluorescence, electrical current for electroluminescence and chemical reaction for chemi-luminscence. An external excitation can be a combination of the above.

The phrase “labeled analyte” refers to an analyte that is detectably labeled with a light emitting label such that the analyte can be detected by assessing the presence of the label. A labeled analyte may be labeled directly (i.e., the analyte itself may be directly conjugated to a label, e.g., via a strong bond, e.g., a covalent or non-covalent bond), or a labeled analyte may be labeled indirectly (i.e., the analyte is bound by a secondary capture agent that is directly labeled).

The term “hybridization” refers to the specific binding of a nucleic acid to a complementary nucleic acid via Watson-Crick base pairing. Accordingly, the term “in situ hybridization” refers to specific binding of a nucleic acid to a metaphase or interphase chromosome.

The terms “hybridizing” and “binding”, with respect to nucleic acids, are used interchangeably.

The term “capture agent/analyte complex” is a complex that results from the specific binding of a capture agent with an analyte. A capture agent and an analyte for the capture agent will usually specifically bind to each other under “specific binding conditions” or “conditions suitable for specific binding”, where such conditions are those conditions (in terms of salt concentration, pH, detergent, protein concentration, temperature, etc.) which allow for binding to occur between capture agents and analytes to bind in solution. Such conditions, particularly with respect to antibodies and their antigens and nucleic acid hybridization are well known in the art (see, e.g., Harlow and Lane (Antibodies: A Laboratory Manual Cold Spring Harbor Laboratory, Cold Spring Harbor, N.Y. (1989) and Ausubel, et al, Short Protocols in Molecular Biology, 5th ed., Wiley & Sons, 2002).

The term “specific binding conditions” as used herein refers to conditions that produce nucleic acid duplexes or protein/protein (e.g., antibody/antigen) complexes that contain pairs of molecules that specifically bind to one another, while, at the same time, disfavor to the formation of complexes between molecules that do not specifically bind to one another. Specific binding conditions are the summation or combination (totality) of both hybridization and wash conditions, and may include a wash and blocking steps, if necessary.

For nucleic acid hybridization, specific binding conditions can be achieved by incubation at 42° C. in a solution: 50% formamide, 5×SSC (150 mM NaCl, 15 mM trisodium citrate), 50 mM sodium phosphate (pH7.6), 5×Denhardt's solution, 10% dextran sulfate, and 20 μg/ml denatured, sheared salmon sperm DNA, followed by washing the filters in 0.1×SSC at about 65° C.

For binding of an antibody to an antigen, specific binding conditions can be achieved by blocking a substrate containing antibodies in blocking solution (e.g., PBS with 3% BSA or non-fat milk), followed by incubation with a sample containing analytes in diluted blocking buffer. After this incubation, the substrate is washed in washing solution (e.g. PBS+TWEEN 20) and incubated with a secondary capture antibody (detection antibody, which recognizes a second site in the antigen). The secondary capture antibody may conjugated with an optical detectable label, e.g., a fluorophore such as IRDye800CW, Alexa 790, Dylight 800. After another wash, the presence of the bound secondary capture antibody may be detected. One of skill in the art would be knowledgeable as to the parameters that can be modified to increase the signal detected and to reduce the background noise.

The term “a secondary capture agent” which can also be referred to as a “detection agent” refers a group of biomolecules or chemical compounds that have highly specific affinity to the antigen. The secondary capture agent can be strongly linked to an optical detectable label, e.g., enzyme, fluorescence label, or can itself be detected by another detection agent that is linked to an optical detectable label through bioconjugatio (Hermanson, “Bioconjugate Techniques” Academic Press, 2nd Ed., 2008).

The term “biotin moiety” refers to an affinity agent that includes biotin or a biotin analogue such as desthiobiotin, oxybiotin, 2′-iminobiotin, diaminobiotin, biotin sulfoxide, biocytin, etc. Biotin moieties bind to streptavidin with an affinity of at least 10-8M. A biotin affinity agent may also include a linker, e.g., -LC-biotin, -LC-LC-Biotin, -SLC-Biotin or -PEGn-Biotin where n is 3-12.

The term “streptavidin” refers to both streptavidin and avidin, as well as any variants thereof that bind to biotin with high affinity.

The term “marker” refers to an analyte whose presence or abundance in a biological sample is correlated with a disease or condition.

The term “bond” includes covalent and non-covalent bonds, including hydrogen bonds, ionic bonds and bonds produced by van der Waal forces.

The term “amplify” refers to an increase in the magnitude of a signal, e.g., at least a 10-fold increase, at least a 100-fold increase at least a 1,000-fold increase, at least a 10,000-fold increase, or at least a 100,000-fold increase in a signal.

The term “local” refers to “at a location”,

Other specific binding conditions are known in the art and may also be employed herein.

It must be noted that as used herein and in the appended claims, the singular forms “a”, “an”, and “the” include plural referents unless the context clearly dictates otherwise, e.g., when the word “single” is used. For example, reference to “an analyte” includes a single analyte and multiple analytes, reference to “a capture agent” includes a single capture agent and multiple capture agents, and reference to “a detection agent” includes a single detection agent and multiple detection agents.

### DETAILED DESCRIPTION OF EXEMPLARY EMBODIMENTS

The following detailed description illustrates some embodiments of the invention by way of example and not by way of limitation.

The invention is related to the devices, systems, and methods that can improve the property of an assay in sensing an analyte, particularly sensing sensitivity, and their making and use. The invention is related to the assays that have a signal amplification layer (SAL) that immobilizes the capture agent and amplifies the captured analytes. The invention is related to significantly increase such amplification. The amplification layer can increase the assay sensitivity without an amplification of the number of molecules. The invention is related to the methods that can make such assays with high throughput and low cost. The analyte include proteins, peptides, DNA, RNA, nucleic acid, small molecules, cells, nanoparticles with different shapes. The targeted analyte can be either in a solution or in air or gas phase. The sensing includes light absorption, light scattering, light radiation, Raman scattering, chromaticity, luminescence that includes fluorescence, electroluminescence, chemiluminescence, and electrochemiluminescence. The sensing property includes the sensing signal intensity, sensing signal spectrum, limit of detection, detection dynamic range, and signal variation reduction (smaller error bar) of the sensing. The sensing includes the detection of the existence, quantification of the concentration, and determination of the states of the targeted analyte. The invention can be used in the sensing in vitro, or in vivo. The assay with a signal amplification layer is sometimes termed as “nanosensor” because of their nanostructures.

One embodiment of the invention is a sensor structure that has metallic disks on pillars with a metallic backplane where the regions with the highest signal amplification (enhancement) are accessible by the analytes.

One embodiment of the invention is a sensor structure that have a metal backplane together with a thin layer metal islands to form plasmonic cavity array to enhance the analyte sensing.

One embodiment of the invention is to have capture agents on the sensor structures to selective bond the targeted analyte specifically. And the analytes may be labeled before and after the capture by the capture agents.

One embodiment of the invention is the fabricate methods that can manufacturing nanosensors over large area with high throughput and low cost.

Nanosensors with a Signal Amplification Layer (SAL)

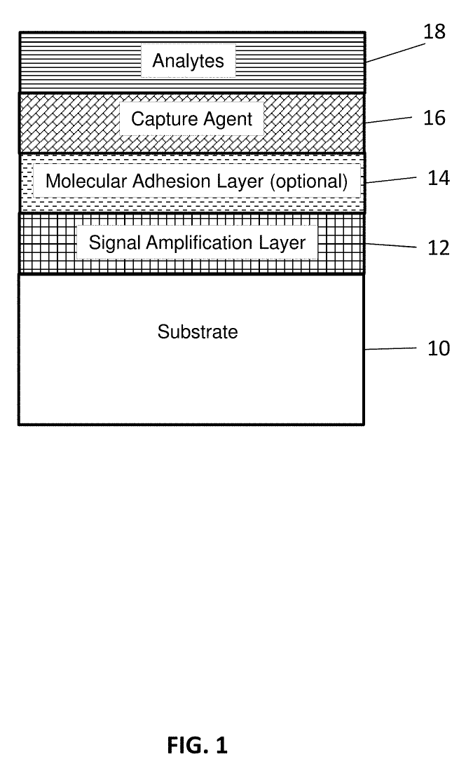

As illustrated by the box diagram in FIG. 1, a nanosensor for sensing an analyte 18, comprise: (a) a substrate 10; (b) a signal amplification layer (SAL) 12 on top of the substrate 10, (c) an optional molecular adhesion layer 14 on the surface of the SAL 12, (d) a capture agent 16 that specifically binds to the analyte 18, wherein the nanosensor amplifies a light signal from an analyte 18, when the analyte is bound to the capture agent 16. The SAL, comprising metallic and non-metallic micro/nanostructures, amplifies the sensing signal of the analytes captured by the capture agent, without an amplification of the number of molecules. Furthermore, such amplification is most effect within the very small depth (˜100 nm) from the SAL surface.

In certain embodiments, the analytes are labeled with a light-emitting label, either prior to or after it is bound to the capture agent. The analytes are also termed as biomarkers in certain embodiments.

In certain embodiment, electric field is also used to assist molecular selectivity, or bonding, and detection.

The analyte include proteins, peptides, DNA, RNA, nucleic acid, small molecules, cells, nanoparticles with different shapes. The targeted analyte can be either in a solution or in air or gas phase. The sensing includes light absorption, light scattering, light radiation, Raman scattering, chromaticity, luminescence that includes fluorescence, electroluminescence, chemiluminescence, and electrochemiluminescence. The sensing property includes the sensing signal intensity, sensing signal spectrum, limit of detection, detection dynamic range, and signal variation reduction (smaller error bar) of the sensing. The sensing includes the detection of the existence, quantification of the concentration, and determination of the states of the targeted analyte. The invention can be used in the sensing in vitro, or in vivo.

The general structures of SAL comprises nanoscale metal-dielectric/semiconductor-metal structures, which amplifies local surface electric field and gradient and light signals. The amplification are the high at the location where there are the sharp (i.e. large curvature) edges of a metal structure and the between a small gaps of the two metal structures. The highest enhancement regions are those having both the sharp edges and the small gaps. Furthermore, the preferred dimensions for all metallic and non-metallic micro/nanostructures should be less than the wavelength of the light the SAL amplifies (i.e. subwavelength).

A preferred SAL layer should have as many the metallic sharp edges and the small gaps as possible. This requires having dense of metallic nanostructures with small gaps apart. The invention includes several different SAL layer structures. Furthermore, the SAL layer itself can be further improved by a process that can further cover the portions of the metallic materials that do not have sharp edges and small gaps, as described in U.S. provisional application Ser. No. 61/801,424, filed on Mar. 15, 2013, and copending PCT application entitled “Methods for enhancing assay sensing properties by selectively masking local surfaces”, filed on Mar. 15, 2014, which are incorporated by reference.

The light amplification comes from one or several following factors: the nanosensor can (a) absorb light excitation effectively (e.g. the light at a wavelength that excites fluorescent moieties), (b) focus the absorbed light into certain locations, (c) place the analytes into the regions where most of light are focused, and (d) radiate efficiently the light generated by analytes from the locations where the analytes immobilized.

In some embodiments, different capture agents are attached to the nanosensor surface with each capture agent coated on a different location of the surface, e.g., in the form of an array, hence providing multiplexing in detections of different analysts, since each location is specific for capturing a specific kind of analyte.

In some embodiments, the nanosensor may be implemented in a multi-well format, e.g., a 24-well, a 96-well or 384 well format, where each well of a multi-well plate comprises a nanosensor (e.g. the nanosensor is in each of the wells or is the bottom or a part sidewall of each well). The capture agent in each well can be the same or different. In some embodiments, multiple different capture agents, each coated on different location can be placed in a well, which provide multiplexing of detections for different analyst. In these embodiments, several analytes in a sample may be analyzed in parallel. In some embodiments, the nanosensor can be a part of micro or nanofluidic channel.

In particular embodiments, a subject nanosensor may further comprise labeled analyte that is specifically bound to the capture agent. As noted above, the labeled analyte may be directly or indirectly labeled with a light-emitting label. In embodiments in which an analyte is indirectly labeled with a light-emitting label, the analyte may be bound to a second capture agent, also termed: detection agent (e.g., a secondary antibody or another nucleic acid) that is itself optically labeled. The second capture agent may be referred to as a “detection agent” in some cases.

In other embodiments, a subject nanosensor may be disposed inside a microfluidic channel (channel width of 1 to 1000 micrometers) or nanofluidic channel (channel width less 1 micrometer) or a part of inside wall of such channels. The nanosensors may be disposes at multiple locations inside each channel and be used in multiple channels. The nanosensors in different locations or different fluidic channels may later coated with different capture agents for multiplexing of detections.

### Exemplary Embodiment for SAL Structures-1: Disk on Pillar (DoP)

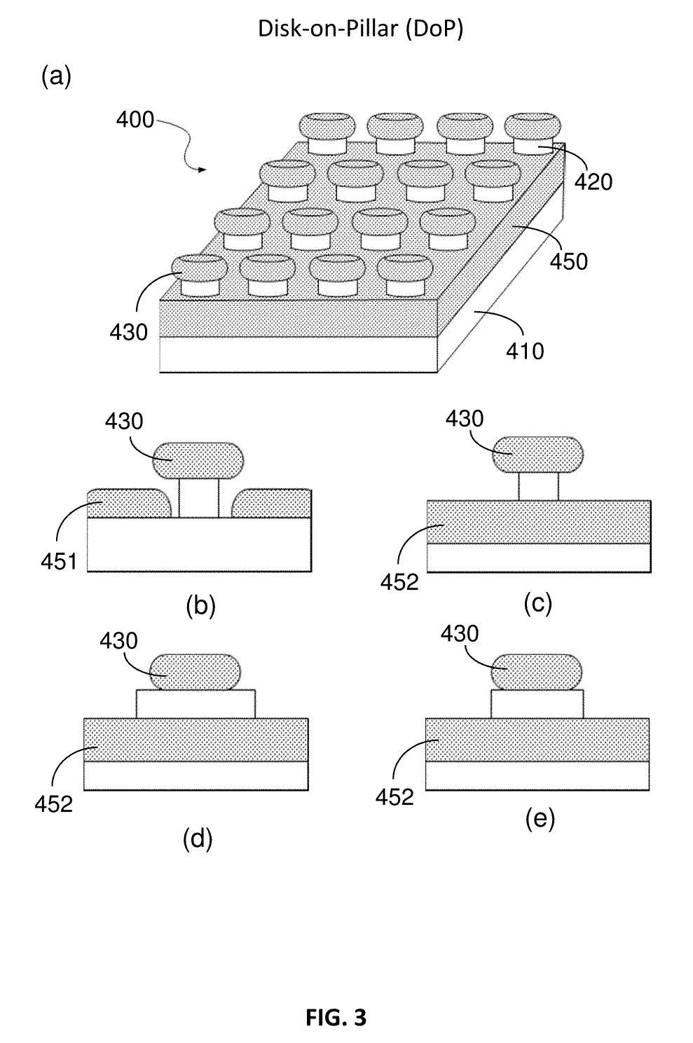

As shown in FIG. 3, certain embodiments of the nanosensor for sensing an analyte, termed “disk on pillars” comprise: (a) a substrate 410; (b) a signal amplification layer 411 comprises: (i) a substantially continuous metallic backplane 450 on the substrate, (ii) one or a plurality of pillars 420 extending from the metallic backplane 450 or from the substrate through holes in the backplane 450, and (iii) a metallic disk 430 on top of the pillar, wherein at least one portion of the edge of the disk has a small separation from one portion of the metallic backplane; (c) a capture agent that specifically binds to the analyte, wherein the capture agent is linked to the surface of the signal amplification layer; wherein the nanosensor amplifies a light signal from an analyte, when the analyte is bound to the capture agent.

When the pillars 420 extends from the metallic backplane 450, the backplane has type B 452: a sheet of film go under the pillar. When or from the substrate through holes in the backplane 450, the metallic backplane is type A 451, near the foot of the pillar covering a substantial portion of the substrate surface. In some case, an nanosensor can by both types. The discs can have a lateral dimension either larger (preferred) or smaller or the same as the pillars. The advantages of type A 451 is the high signal amplification regions of the nanosensor are accessible to the analytes to be detected. The structure with disk lateral dimension larger than that of the pillar offers similar advantage, and hence preferred. In cases, additional etching in the fabrication to further reduce the pillar size while keeping the metallic disk size fixed (see fabrication section). Furthermore, in certain embodiments, nanodots can be added to the outer surface of sidewall of the pillars.

The preferred dimensions for metallic disks, the pillars, and the separations should be less than the wavelength of the light the SAL amplifies (i.e. subwavelength). For examples, for enhancing light of a wavelength of 400 nm to 1,000 nm (visible to near-infra-red), the separation should be 0.2 nm to 50 nm, preferably 0.2 to 25 nm, the average disc's lateral dimension is from 20 nm to 250 nm, and the disk thickness is from 5 nm to 60 nm, depending upon the light wavelength used in sensing.

Exemplary Embodiment for SAL Structure-2: Random Metallic Nano-Islands with Metallic Backplane

The metallic disc can be random metallic nano-islands. Such structure has a low cost advantage in certain situations. Such structure is termed “plasmonic cavity by metallic-island-sheet and metallic-backplane” (PCMM). The PCC comprises random metallic nanoislands (530) located on top of a continuous dielectric film (521) (instead of pillars) on top of a sheet of metal film (550).

### Exemplary Embodiment for SAL Structure-3: D2PA

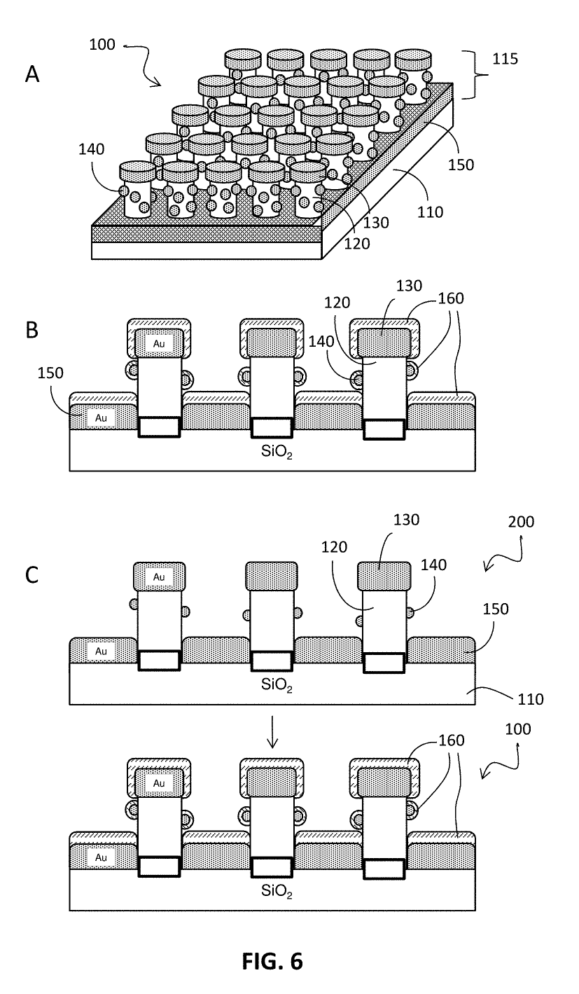

With reference to FIG. 6, a D2PA plate is a plate with a surface structure, termed “disk-coupled dots-on-pillar antenna array”, (D2PA), 100 comprising: (a) substrate 110; and (b) a D2PA structure, on the surface of the substrate, comprising one or a plurality of pillars 115 extending from a surface of the substrate, wherein at least one of the pillars comprises a pillar body 120, metallic disc 130 on top of the pillar, metallic backplane 150 at the foot of the pillar, the metallic backplane covering a substantial portion of the substrate surface near the foot of the pillar; metallic dot structure 140 disposed on sidewall of the pillar. The D2PA amplifies a light signal that is proximal to the surface of the D2PA. The D2PA enhances local electric field and local electric field gradient in regions that is proximal to the surface of the D2PA.

### General Shapes and Dimensions of D2PA.

In some embodiments, the dimensions of one or more of the parts of the pillars or a distance between two components may be that is less than the wavelength of the amplified light. For example, the lateral dimension of the pillar body 120, the height of pillar body 120, the dimensions of metal disc 130, the distances between any gaps between metallic dot structures 140, the distances between metallic dot structure 140, and metallic disc 130 may be smaller than the wavelength of the amplified light. In some embodiments, the metallic dots are not used, just the metallic disks and the metallic backplane separated by a gap.

As illustrated in FIG. 3, the pillars may be arranged on the substrate in the form of an array. In particular cases, the nearest pillars of the array may be spaced by a distance that is less than the wavelength of the light. The pillar array can be periodic and aperiodic.

### Metallic Disc's Dimensions for all SAL Layers.

The disk array can be periodic 430 and aperiodic 501. The metallic disks in all embodiments have a shape selected from the group of shapes consisting of round, polygonal, pyramidal, elliptical, elongated bar shaped, or any combination thereof. Each disk may have the same, similar or different shapes with the other disks. The metallic disc on the top of each pillar can have a shape of rounded, pointed (as in the form of a pyramid or cone), polygonal, elliptical, elongated bar, polygon, other similar shapes or combinations thereof. The metallic disc lateral dimension and thickness should be less than the light amplified wavelength. Depending upon the amplified light wavelength, a lateral dimension of each disc can be chosen from 4 nm to 1500 nm, and a thickness of the disc is from 1 nm to 500 nm. The shape of each disc can be the same as, smaller, or larger, or different from, the shape of the top surface of the associated pillar on which it is disposed. The shape difference can be various from 0 to 200 nm depending the working wavelength.

Pillar's and Non-Metallic Layer's Materials and Dimensions for all SAL Layers with Pillars.

The pillar array can be periodic and aperiodic. The pillar bodies on the top layer of the substrate for the SAL with the pillars and the non-metallic layer for the SAL without the pillars may be formed from an insulating material, but may be semiconductors. Exemplary materials for the formation of the pillars are dielectrics: polymers, silicon-dioxide, silicon-nitride, hafnium oxide (HfO), Aluminum oxide (AlO) or semiconductors: silicon, GaAs, and GaN.

Once formed, the pillars may have sidewalls which are columnar (straight), sloped, curved, or any combination thereof. The shape of the top surface of the pillar can be round, a point (of a pyramid), polygon, elliptical, elongated bar, polygon, other similar shapes or combinations thereof. The height of each pillar may be chosen from 5 nm to 300 nm.

The lateral dimension of each pillar should be less the amplified light wavelength, and should be chosen from 5 nm to 8,000 nm, according the amplified light wavelength. The spacing between the pillars in the array can be periodic or aperiodic. The preferred spacing should be less than amplified light wavelength. For some applications, a periodic period is preferred and the period is chosen to maximize the light absorption and radiation, which is light wavelength dependent. The spacing (pitch) between adjacent pillars in the array may be from 4 nm to 4000 nm.

### Metallic Backplane's Materials and Dimensions for all SAL Layers:

The metallic backplane 150, 450, 503 works together with the metallic disks to form a light cavity. In the embodiment, the metallic back plane defines a metallic layer on the substrate with a hole for each pillar. The hole size should be less than the amplified light wavelength. The thickness of the metallic back plane is selected to be from 1 nm to 2000 nm, with a thickness in the range of 50 nm-200 nm preferred. The material of the metallic back plane can be selected from the same group as is used to form the metallic disc described above, but for a given D2PA structure, the metallic back plane can be formed from either the same or a different material as that used to form the discs. The D2PA nanodevice of any prior claim, wherein the pillar has a sidewall surface that is columnar, sloped, or curved.

Metallic Dots' Materials and Dimensions for all SAL Layers with Dots.

Disposed on the sidewalls of each pillar between the metallic disc and the metallic back plane, the metallic dots 140 have shapes which are approximately spherical, discs-like, polygonal, elongated, other shapes or combinations thereof. The metallic dots 140 on a pillar may all have approximately the same shape, or may be individually varied. The dimensions of the metallic dots should be smaller than the amplified light wavelength, and are, depending the amplified light wavelength, preferably between 3 nm to 600 nm, and may be different in three dimensions. In some embodiments, the gaps between the neighboring metallic dots and the gap between the disc and adjacent metallic dots is between 0.5 nm to 200 nm. For many applications, a small gap is preferred to achieve a stronger enhancement of the signals. The gaps may be varied between each metallic dot on a pillar.

### Metallic Materials for all SALs:

The metallic materials for the metallic disks, backplanes, and dots are chosen from (a) single element metal, such as gold, silver, copper, aluminum, nickels; (b) a combination of the multiplayer and/or multilayer of the single metals; (c) metallic alloys; (d) semiconductors, (e) any other materials that generate plasmons at the amplified light wavelength, or (f) any combination of (a), (b), (c), (d) and (e). Each of the metallic disks, backplane, and dots use the same metallic materials as the others or different metallic materials.

### Substrates for all SALs.

The substrate 110, 410, 504 offer physical support to the D2PA and should be any materials, as long as it does not generate chemical and electromagnetic interference to the D2PA amplification. The substrate also can be in many different forms: thin film (membrane) and thick plate, flexible and rigid. The substrate may be made of a dielectric (e.g., SiO₂) although other materials may be used, e.g., silicon, GaAs, polydimethylsiloxane (PDMS), poly(methyl methacrylate) (PMMA).

### Preferred D2PA Embodiments.

All dimensions of the critical elements of D2PA are less the wavelength of the light. The metallic materials are selected from gold, silver, cooper, and aluminum and their alloys. In one embodiment that is configured for enhance light at a wavelength of −800 nm, the D2PA nanostructure may be composed of a periodic non-metallic (e.g. dielectric or semiconductor) pillar array (200 nm pitch and −100 nm diameter), a metallic disk on top of each pillar, a metallic backplane on the foot of the pillars, metallic nanodots randomly located on the pillar walls, and nanogaps between these metal components. The metallic disk has −120 nm diameter and is slightly larger than the diameter of the pillar, hence having an overhang. The disk array and the backplane (both are 40 nm thick) form a 3D cavity antenna that can efficiently traps the excitation light vertically and laterally. The height of the pillar is −50 nm and hence the nearest distance between the metallic disk and the metallic backplane is about 10 nm. The nearest distance, often termed “nanogap”, is preferred as small as possible for a higher enhancement. Each pillar has about 3 to 30 nanodots depending upon the pillar geometry and fabrication processing conditions; and the pillar density is 2.5×10⁹ pillars/cm². Again, In some embodiments, the metallic dots are not used, just the metallic disks and the metallic backplane separated by a gap.

### Other SAL Layers.

Another embodiment of the sensing implication surface comprises a or a plural of metallic discs on a substrate and the average disc's lateral dimension of from 20 nm to 250 nm, and has at least a gap of 0.5 to 30 nm between the two adjacent discs.

### Capture Agents and Attachment of the Same

The capture agents 16 for the target analytes are immobilized either directly on the signal amplification layer (SAL) 12 or through a thin molecular adhesion/spacer layer (MAL) 16.

In one embodiment, the capture agents 16 are attached primarily in the regions of high electric field and/or high electric field, namely, the regions with sharp edges of metallic materials and the small gap. One method of achieving this is to (a) use end functional group in either the capture agent (for direct attachment) or the MAL, that attaches only the metal, and (b) selectively mask the metal surfaces which have a low local electric field or low local electric field gradient (as described in U.S. provisional application Ser. No. 61/801,424, filed on Mar. 15, 2013, and copending PCT application entitled “Methods for enhancing assay sensing properties by selectively masking local surfaces”, filed on Mar. 15, 2014, which are incorporated by reference.

The molecular adhesion/spacer layer (MAL) 14, coated on outer surface of the SAL 12 (the inner surface of SAL is the surface in contact with the substrate surface), serves one of the two or both of the functions: (1) provide a good adhesion to bond to the capture agents, and (2) a spacer that control the distance between the metal in the SAL and the signal generation molecule to optimize signal amplification. One preferred SAL embodiment is that the dimension of one, several or all critical metallic and dielectric components of SAL are less than the wavelength of the light in sensing.

Examples for the molecular spacer thickness: The thickness of the spacer (i.e. MAL), that separate the metal from the molecules that generate optical signal, is from 1 nm to 50 nm for fluorescence (preferred for 5 nm for −800 nm light wavelength); and 1 to 15 nm for surface enhanced Raman scattering (SERS). The thickness depends on the wavelength of light.

As shown in FIG. 6, nanodevice 100 comprises a molecular adhesion layer 160 that covers at least a part of the metal surfaces of the underlying D2PA. The molecular adhesion layer has two purposes. First, the molecular adhesion layer acts a spacer. For optimal fluorescence, the light-emitting labels (e.g., fluorophores) cannot be too close to the metal surface because non-radiation processes would quench fluorescence. Nor can the light-emitting labels be too far from the metal surface because it would reduce amplification. Ideally, the light-emitting labels should be at an optimum distance from the metal surface. Second, the molecular adhesion layer provides a good adhesion to attach capture agent onto the nanodevice. The good adhesion is achieved by having reactive groups in the molecules of the molecular adhesion layer, which have a high affinity to the capture agent on one side and to the nanodevices on the other side.

The molecular adhesion layer (MAL) 160 can have many different configurations, including (a) a self-assembled monolayer (SAM) of cross-link molecules, (b) a multi-molecular layers thin film, (c) a combination of (a) and (b), and (d) a capture agent itself.

In the embodiment of MAL (a), where the molecular adhesion layer 160 is a self-assembled monolayer (SAM) of cross-link molecules or ligands, each molecule for the SAM comprises of three parts: (i) head group, which has a specific chemical affinity to the nanodevice's surface, (ii) terminal group, which has a specific affinity to the capture agent, and (iii) molecule chain, which is a long series of molecules that link the head group and terminal group, and its length (which determines the average spacing between the metal to the capture agent) can affect the light amplification of the nanodevice. Such a SAM is illustrated in FIG. 3.

In many embodiments, the head group attached to the metal surface belongs to the thiol group, e.t., —SH. Other alternatives for head groups that attach to metal surface are, carboxylic acid (—COOH), amine (C═N), selenol (—SeH), or phosphane (—P). Other head groups, e.g. silane (—SiO), can be used if a monolayer is to be coated on dielectric materials or semiconductors, e.g., silicon.

In many embodiments, the terminal groups can comprise a variety of capture agent-reactive groups, including, but not limited to, N-hydroxysuccinimidyl ester, sulfo-N-hydroxysuccinimidyl ester, a halo-substituted phenol ester, pentafluorophenol ester, a nitro-substituted phenol ester, an anhydride, isocyanate, isothiocyanate, an imidoester, maleimide, iodoacetyl, hydrazide, an aldehyde, or an epoxide. Other suitable groups are known in the art and may be described in, e.g., Hermanson, “Bioconjugate Techniques” Academic Press, 2nd Ed., 2008. The terminal groups can be chemically attached to the molecule chain after they are assembled to the nanodevice surface, or synthesized together with the molecule chain before they are assembled on the surface.

Other terminal groups are Carboxyl —COOH groups (activated with EDC/NHS to form covalent binding with —NH2 on the ligand); Amine, —NH2, group (forming covalent binding with —COOH on the ligand via amide bond activated by EDC/NHS); Epoxy, Reacted with the —NH2 (the ligand without the need of a cross-linker); Aldehyde, (Reacted with the —NH2 on the ligand without the need of a cross-linker); Thiol, —SH, (link to —NH2 on the ligand through SMCC-like bioconjugation approach); and Glutathione, (GHS) (Ideal for capture of the GST-tagged proteins.

The molecular chain can be carbon chains, their lengths can be adjusted to change the distance between the light emitting label to the metal for optimizing the optical signal. In one embodiment, as will be described in greater detail in example section, the SAM layer is dithiobis(succinimidyl undecanoate), whose head group is —SH that binds to gold surface through sulfer-gold bond, and terminal group is NHS-ester that bind to the primary amine sites of the capture agent, and the molecule alkane chain with length of 1.7 nm.

In many embodiments, the molecule chains that link head groups and terminal groups are alkane chain, which is composed of only hydrogen and carbon atoms, with all bonds are single bonds, and the carbon atoms are not joined in cyclic structures but instead form a simple linear chain. Other alternatives for molecule chain can be ligands that are from polymers such as poly(ethylene glycol) (PEG), Poly(lactic acid) (PLA), etc. The molecule chains are chemically non-reactive to neither the metal surface that the head groups attach to, nor the capture agent that the terminal groups attach to. The chain length, which determines the distance of analyte to the nanodevice's surface, can be optimized in order to achieve the maximum signal amplification. As will be described in greater detail below, the molecule chains may have a thickness of, e.g., 0.5 nm to 50 nm.

The molecular adhesion layer used in the subject nanosensor may be composed of a self-assembled monolayer (SAM) that is strongly attached to the metal at one side (via, e.g., a sulfur atom) and that terminates a capture-agent-reactive group, e.g., an amine-reactive group, a thiol-reactive group, a hydroxyl-reactive group, an imidazolyl-reactive group and a guanidinyl-reactive group, at the other (exterior) side. The monolayer may have a hydrophobic or hydrophilic surface. The most commonly used capture-agent reactive groups are NHS (which is amine-reactive) and maleimide (which is sulfhydrl-reactive), although many others may be used.

In some embodiments, the molecular adhesion layer may be a self-assembled monolayer of an alkanethiol (see, e.g., Kato Journal of Physical Chemistry 2002 106: 9655-9658), poly(ethylene)glycol thiol (see, e.g., Shenoy et al Int. J. Nanomedicine. 2006 1: 51-57), an aromatic thiol or some other chain that terminates in the thiol.

Thiol groups may be used because (a) the thiol sulfur interacts with gold and other metals to form a bond that is both strong and stable bond (see, e.g., Nuzzo et al J. Am. Chem. Soc. 1987 109:2358-2368) and (b) van der Waals forces cause the alkane and other chains chains to stack, which causes a SAM to organize spontaneously (see, e.g., Love et al. Chem. Rev. 2006 105:1103-1169). Further, the terminal group is available for either direct attachment to the capture molecule or for further chemical modifications.

Alkanethiol may be used in some embodiments. It has been estimated that there are 4×10¹⁴ alkanethiol molecules/cm² in a packed monolayer of alkanethiol (Nuzzo et al, J. Am. Chem. Soc. 1987 109:733-740), which approximately corresponds to an alkanethiol bond to every gold atom on the underlying surface. Self-assembled monolayers composed of alkanethiol can be generated by soaking the gold substrate in an alkanethiol solution (see, e.g., Lee et al Anal. Chem. 2006 78: 6504-6510). Gold is capable of reacting with both reduced alkanethiols (—SH groups) and alkyldisulfides (—S—S—) (see, e.g., Love et al Chem. Rev. 2005 105:1103-1169).

Once a self-assembled monolayer of poly(ethylene)glycol thiol or alkanethiol has been produced, a large number of strategies can be employed to link a capture to the self-assembled monolayer. In one embodiment, a capture agent such as streptavidin (SA) can be attached to the SAM to immobilize biotinylated capture agents.

In one embodiment, streptavidin (SA) itself can be use as a functional group (e.g. terminal group) the SAM to crosslink capture agent molecules that have high binding affinity to SA, such as biotinylated molecules, including peptides, oligonucleotides, proteins and sugars.

The functional group of avidin, streptavidin have a high affinity to the biotin group to form avidin-biotin. Such high affinity makes avidin/streptavidin serve well as a functional group and the biotin group as complementary functional group binding. Such functional group can be in binding the molecular adhesion layer to the nanodevice, in binding between molecular adhesion layer and the capture agent, and in binding a light emitting lable to the secondary capture agent. In one embodiment, a molecular adhesion layer containing thiol-reactive groups may be made by linking a gold surface to an amine-terminated SAM, and further modifying the amine groups using sulfosuccinimidyl-4-(N-maleimidomethyl)cyclohexane-1-carboxylate (Sulfo-SMCC) to yield a maleimide-activated surface. Maleimide-activated surfaces are reactive thiol groups and can be used to link to capture agents that contain thiol- (e.g., cysteine) groups.

In another embodiment, a molecular adhesion layer containing an amine-reactive group (N-hydroxl succinimide (NHS)) can be produced by, e.g., by soaking the gold substrate in a 1-10 mM solution of succinimidyl alkanedisulfides such as dithiobis-sulfosuccinimidylpropionate (DSP) or dithiobis(succinimidyl undecanoate) (see, e.g., Peelen et al J. Proteome Res. 2006 5:1580-1585 and Storri et al Biosens. Bioelectron. 1998 13: 347-357).

In another embodiment, a molecular adhesion layer containing an amine-reactive group (NHS) may be produced using carboxyl-terminated SAM such as 12-carboxy-1-undecanethiol. In this case, the surface of the SAM may be linked to the NHS in the presence of 1-ethyl-3(3dimethylaminopropyl)carbodiimide HCl (EDC) to yield an inter-mediate which forms stable amide bonds with primary amines (see, e.g., Johnsson et al Anal. Biochem. 1001 198: 268-277).

In another embodiment, a molecular adhesion layer may contain Protein A which binds with high affinity to Fc region of IgGs, other immunoglobulin form, e.g., IgE.

In another embodiment, an imidazole group (which is also reactive with amines) may be added by reacting a carboxyl-terminated SAM with 1,1′-carbonyldiimidazole (CDI).

In further embodiments, aldehyde-terminated alkanethiol monolayers can be used to immobilize both proteins and amine-terminated DNA oligonucleotides, and his-tagged fusion proteins can be immobilized on nitrilotriacetic (NTA)-modified gold surfaces.

Thiol-reactive groups can link to synthetic DNA and RNA oligonucleotides, including aptamers, which can be readily synthesized commercially with a thiol terminus. Thiol-reactive groups can also link to proteins that contain a cysteine groups, e.g., antibodies. Thiolated molecules can be attached to maleimide-modified surfaces (see, e.g., Smith et al Langmuir 2002 19: 1486-1492). For in certain cases, one may use an amino acid spacer (e.g., Ser-Gly-Ser-Gly) inserted after a terminal Cys, which improves the amount of binding relative peptides that lacking spacers. For oligonucleotides, an alkane spacer can be used. Carbohydrates synthesized to contain with terminal thiols can be been tethered to gold in the same way.

Amine-reactive groups can form bonds with primary amines, such as the free amine on lysine residues. In addition to proteins, amine-reactive surfaces can be used to immobilize other biomolecules, including peptides containing lysine residues and oligonucleotides synthesized with an amine terminus.

In the embodiment of MAL (b), in which the molecular adhesion layer 160 is a multi-molecular layer thin film, the molecules may be coated on the D2PA nanodevice through physical adsorption or strong binding. In one example, protein A can be coated over the entire or partial areas of the surface of D2PA nanodevice surface, in which case the protein A can be deposited through physical adsorption process and has a thickness of 4 nm to 5 nm. In another example, the layer may be a thin film of a polymer such as polyethylene glycol (PEG), which has a functional head group on one end, e.g., thiol (—SH). The functioned PEG molecule layer forms a strong bond to D2PA nanodevice's surface. The thickness of PEG molecule layer can be tuned by changing the PEG polymer chain length. Another example is an amorphous SiO2 thin film, which is attached to the surface of the D2PA nanodevice using physical or chemical deposition methods, e.g., evaporation, sputtering, sol-gel method. The thickness of the SiO2 thin film can be precisely controlled during the deposition.

In the embodiment of MAL (c), where the molecular adhesion layer 160 is a combination of a multi-molecular layer thin film and a SAM, the SAM layer may be deposited first, followed by a multi-molecular layer.

In one example, the molecular adhesion layer may contain a monolayer of streptavidin first, followed by other layers of molecules that have high binding affinity to streptavidin, such as biotin, biotinylated molecules, including peptides, oligonucleotides, proteins, and sugars.

In one example, the molecular adhesion layer, may contain a SAM layer dithiobis(succinimidyl undecanoate) (DSU) and a Protein A layer. The DSU SAM layer binds to nanodevice's metal surface through sulfer-gold bond, and has a terminal group of NHS-ester that binds to the primary amine sites on Protein A. In a particular case, capture antibodies bond to such bilayer of protein A on top of DSU through their Fc region. The protein A can ensure the orientation of antibodies for better capture efficiency.

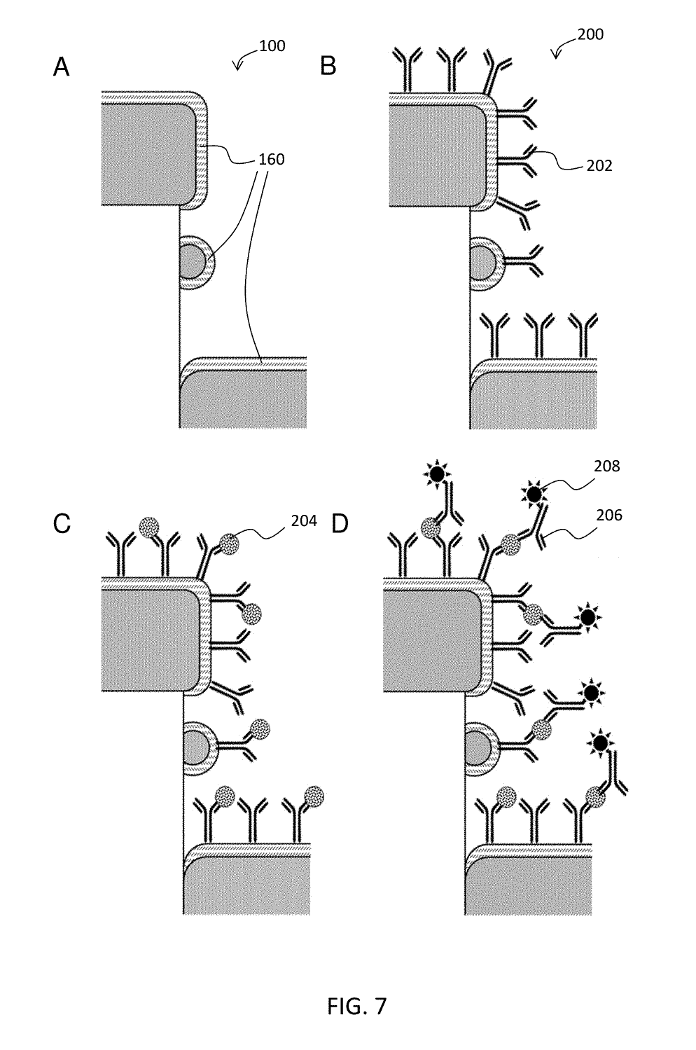

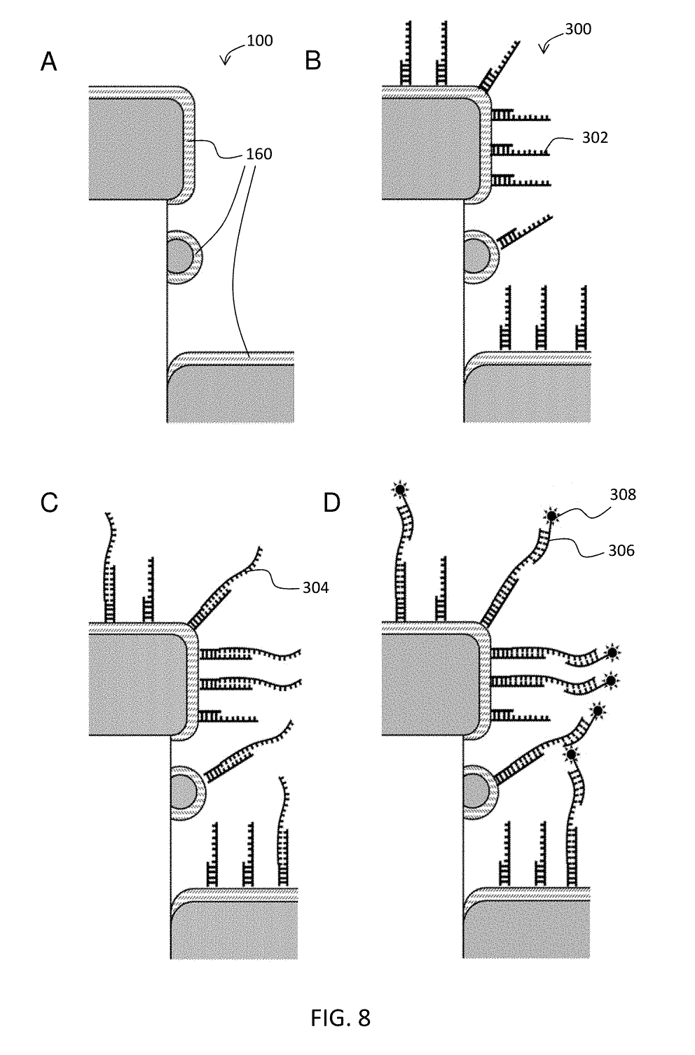

In the embodiment of MAL (d), where the molecular adhesion layer 160 is a capture agent itself, the capture agent has a headgroup that have a high affinity to the metal or pillar sidewall of the subject nanodevice (i.e. D2PA). One of the common headgroup is thiol-reactive group. Thiol-reactive groups can link to synthetic DNA and RNA oligonucleotides, including aptamers, which can be readily synthesized commercially with a thiol terminus. Thiol-reactive groups can also link to proteins that contain a cysteine groups, e.g., antibodies. Another example where the MAL itself is used as the capture agent is a layer of antibody fragments, e.g., half-IgG, Fab, F(ab′)2, Fc. The antibody fragments bond to metal surface directly through the thiol-endopeptidase located in the hinge region. This embodiment is illustrated in FIG. 8. In this embodiment, the nucleic acid comprises a headgroup that binds directly the nanodevice. The remainder of the steps are performed as described in FIG. 7.

The thickness of molecular adhesion layer should be in the range of 0.5 nm to 50 nm, e.g., 1 nm to 20 nm. The thickness of the molecular adhesion layer can be optimized to the particular application by, e.g., increasing or decreasing the length of the linker (the alkane or poly(ethylene glycol) chain) of the SAM used. Assuming each bond in the linker is 0.1 nM to 0.15 nM, then an optimal SAM may contain a polymeric linker of 5 to 50 carbon atoms, e.g., 10 to 20 carbon atoms in certain cases.

A nanosensor may be made by attaching capture agents to the molecular adhesion layer via a reaction between the capture agent and a capture-agent reactive group on the surface of the molecular adhesion layer.

Capture agents can be attached to the molecular adhesion layer via any convenient method such as those discussed above. In many cases, a capture agent may be attached to the molecular adhesion layer via a high-affinity strong interactions such as those between biotin and streptavidin. Because streptavidin is a protein, streptavidin can be linked to the surface of the molecular adhesion layer using any of the amine-reactive methods described above. Biotinylated capture agents can be immobilized by spotting them onto the streptavidin. In other embodiments, a capture agent can be attached to the molecular adhesion layer via a reaction that forms a strong bond, e.g., a reaction between an amine group in a lysine residue of a protein or an aminated oligonucleotide with an NHS ester to produce an amide bond between the capture agent and the molecular adhesion layer. In other embodiment, a capture agent can be strongly attached to the molecular adhesion layer via a reaction between a sulfhydryl group in a cysteine residue of a protein or a sulfhydrl-oligonucleotide with a sulfhydryl-reactive maleimide on the surface of the molecular adhesion layer. Protocols for linking capture agents to various reactive groups are well known in the art.

In one embodiment, capture agent can be nucleic acid to capture proteins, or capture agent can be proteins that capture nucleic acid, e.g., DNA, RNA. Nucleic acid can bind to proteins through sequence-specific (tight) or non-sequence specific (loose) bond.

In certain instances, a subject nanodevice may be fabricated using the method: (a) patterning at least one pillar on a top surface of a substrate; (b) depositing a metallic material layer of the top surface; (c) allowing the metallic material deposited on the pillar tops to form a disc, the metallic material deposited on the pillar feet to form a metallic back plane, and the metallic material deposited on the sidewall to form at least one metallic dot structure; and, as described above, (d) depositing a molecular adhesion layer on top of the deposited metallic material, wherein the molecular adhesion layer covers at least a part of the metallic dot structure, the metal disc, and/or the metallic back plane, and wherein the exterior surface of the molecular adhesion layer comprises a capture agent-reactive group.

Furthermore, the patterning in (a) include a direct imprinting (embossing) of a material, which can be dielectric or semiconductor in electric property, and can be polymers or polymers formed by curing of monomers or oligomers, or amorphous inorganic materials. The material can be a thin film with a thickness from 10 nanometer to 10 millimeter, or multilayer materials with a substrate. The imprinting (i.e. embossing) means to have mold with a structure on its surface, and press the mold into the material to be imprinted to for an inverse of the structure in the material. The substrates or the top imprinted layers can be a plastic (i.e. polymers), e.g. polystyring (PS), Poly(methyl methacrylate) (PMMA), Polyethylene terephthalate (PET), other acrylics, and alike. The imprinting may be done by roll to roll technology using a roller imprinter. Such process has a great economic advantage and hence lowering the cost.

### Fabrication of Nanosensors

The nanosensors can be fabricated in large area with high throughput and low cost by using nanoimprint technology, including the roller nanoimprint or roll to roll nanoimprint. In roller nanoimprint, either mold or the substrate is in the roll form. In the roll-to-toll nanoimprint, both the mold and substrates are the rolls. The nanoimprint based on roller technology refers to roller nanoimprint and roll-to-roll nanoimprint.

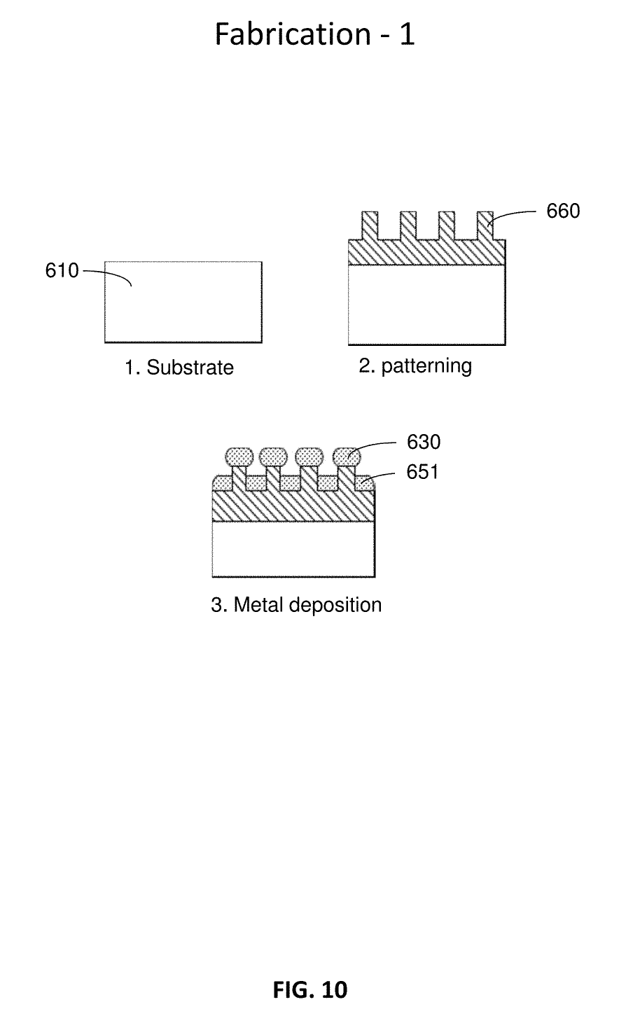

FIG. 10 shows the exemplary fabrication method-1, direct pillar forming, comprising: 1. prepare a substrate 610; 2. directly pattern the pillar array 620 by nanoimprint lithography; 3. metal is deposited to form metal disk on top 630 and metal backplane 651. In certain embodiments of the methods, the nanodots can be formed on the pillar sidewall. The nanoimprint can be roll nanoimprint or roll-to-roll nanoimprint. The substrate can be flexible thin film either non-metallic, or with a thin metallic film on the surface.

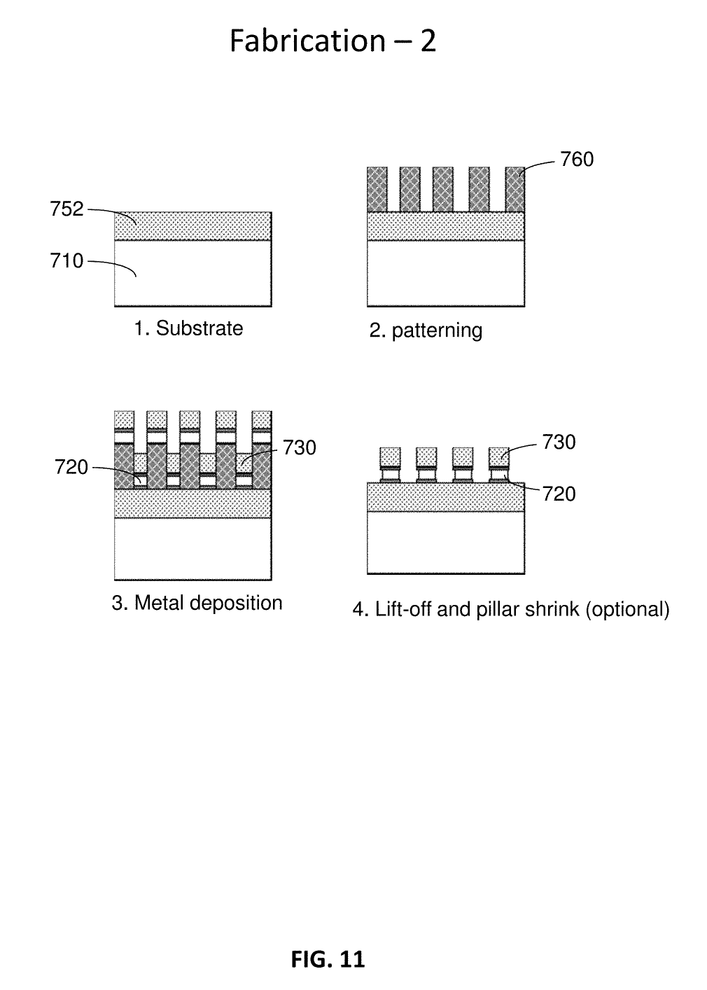

FIG. 11 shows the exemplary fabrication method-2, pillar-disk forming by lift-off, comprising: 1. prepare a substrate 710, covered by a metal layer 752; 2. lithography (e.g., nanoimprint lithography) is performed to pattern resist 660 and residual resist is etched out to exposed gold covering 752 on substrate; 3. dielectric material and metal is deposited successively to form dielectric pillar 820 and metal top disk 730; 4. After lift-off resist 760, dielectric pillar 720 can be further shrunk to enhance performance.

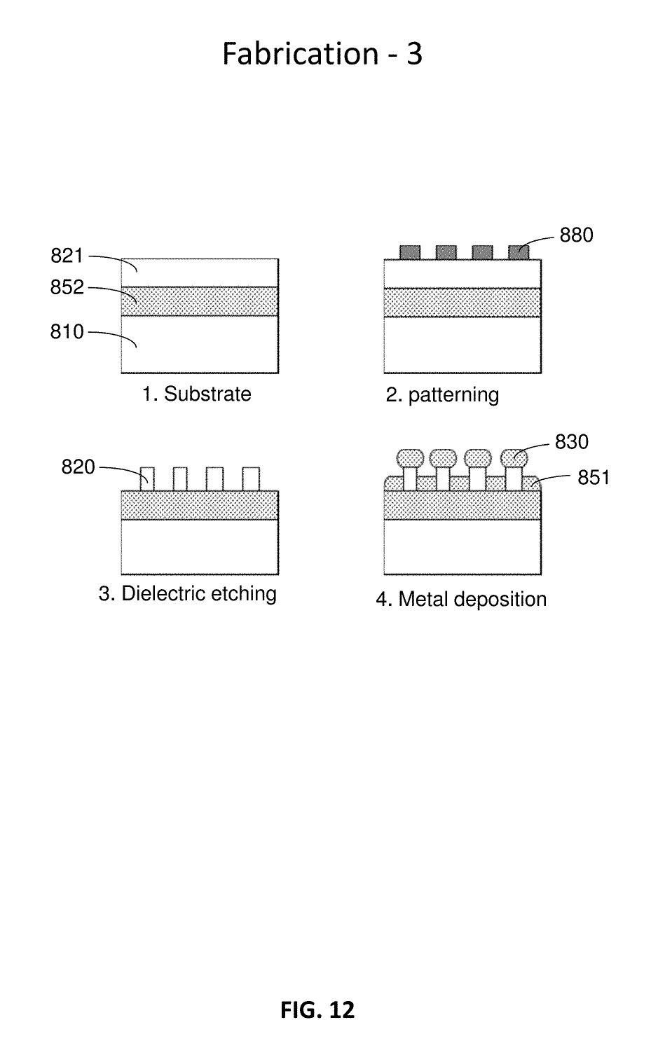

FIG. 12 shows the exemplary fabrication method-3, pillar forming by etching, comprising: 1. prepare a substrate 810, covered by a thick metal layer 852 and another dielectric layer 821; 2. lithography (e.g., nanoimprint lithography) and lift-off is performed to form Cr mask pattern array 880; 3. By Cr masking 880, top dielectric is etched into pillar array 820; 4. Final metal deposition forms top metal disk 830 and metal backplane 851 simultaneously.

The imprint mold material: The mold material can be hard (silicon, silica, etc.), or soft (PDMS, PFPE, etc.), as long as it has low adhesion to the deposited metal film for ease of demolding;

One of the advantages of DoP is that it can be achieved in large-scale manufactures by well-developed standard fabrication process. In particular, patterning by nanoimprint technology allows a fast and low-cost manufacture of DoP over large area. The key novelties in DoP structure manufacture include:

Substrate provides mechanical support to the DoP nanostructure on top. One of the advantages of DoP is that it is suitable for manufacture on top of both hard substrate (such as SiO2 covered silicon substrate, silica substrate, sapphire substrate) and soft substrate (such as plastic substrate). The importance of compatibility of DoP to soft substrate includes: (1) plastic substrate are flexible, which is suitable for state-of-the-art large-area patterning technology such as roller imprint technology. This is the key feature for expanding product output and lowering the manufacture cost. In addition, the substrate flexibility allows lower requirement for product protection during the manufacture handling and practical use. (2) Most plastic substrates are naturally dielectric material, which do not require additional coating process of dielectric layer before metallic back plane deposition. (3) By using transparent plastic substrate, the high transparency of plastic substrate broadens the capacity of DoP in optical applications.

Materials of plastic for the purpose of DoP substrate can be in a wide range of polymers, including (but not limited to) Polyethylene terephthalate (PET), polyimide (PI), and Polyether ether ketone (PEEK).

For large-scale DoP manufacture, using metal sputtering and e-beam evaporation to deposit the metallic back plane might not be efficient. A feasible way to achieve large-area metal coating is metal electroplating. It only requires a thin seeding layer deposition beforehand. During plating, target (DoP substrate) is submerged in electrolyte and connected to cathode, while the anode connects to a small piece of pure metal that form the back plane. Electroplating facilitates low-cost and fast metal coating in DoP manufacture.

In small-scale fabrication, imprint resist can be spin-coated on hard substrate, given the substrate is in round shape. In large-scale manufacture, such spin-coating requires a very large spinner and powerful motor to drive. Instead, imprint resist can be coating on large-area substrate by blade-coating, spray-coating, or roll-to-roll (R2R) coating. In particular, spray-coating applies a small nozzle to uniformly print resist droplets on the substrate surface. Roll-to-roll coating transfer resist from resist roller onto the DoP substrate on the target roller. This setup can be directly integrated into the roller imprint system.

Dielectric pillar and top disk forming can be achieved by evaporation. Other low-temperature deposition process might also work, as long as it does not change the resist profile.

The last process of pillar size tuning is optional. Its purpose is to finely tune the relative position of dielectric pillar and the top metallic disk. There are two ways to achieve the size tuning: by dry-etch and by wet-etch. In dry etch, the gas pressure has to be set to high in order to induce isotropic etching. For both etching method, the size shrinking is precisely controlled by etching time. Depending on the dielectric materials of the pillar, etching gas recipe (for dry etching) or etching chemicals (for wet etching) could be different.

Fabrication of PCMM.

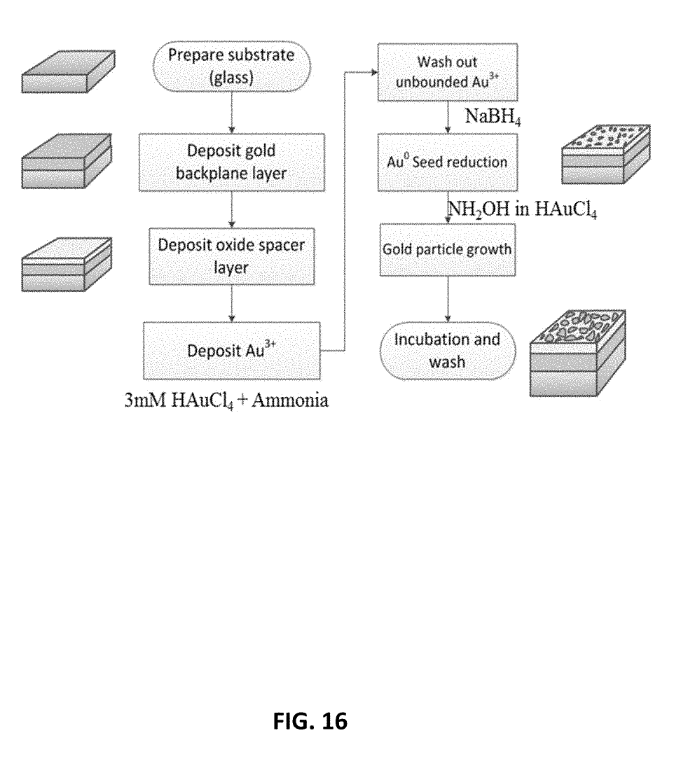

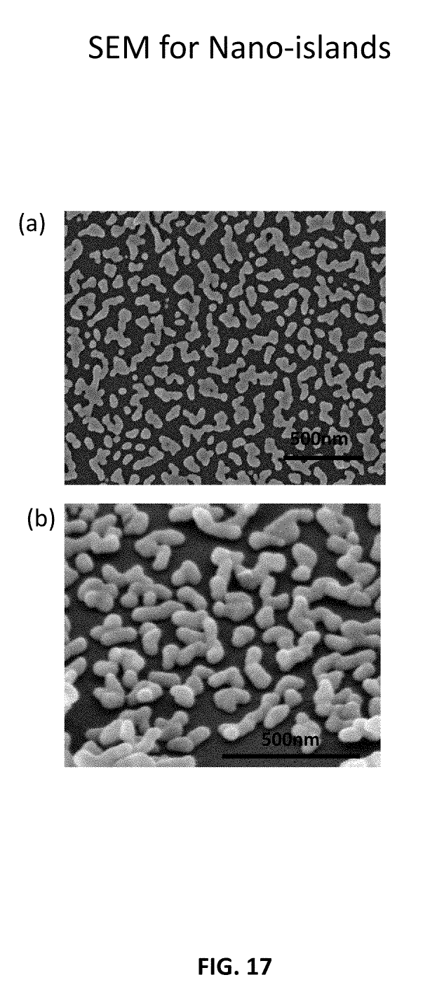

The fabrication process of PCMM structure is as follows (gold is used as an example here, and the thickness of each layer need not to be strict, depending of practical applications): first, a 60 nm-thick gold film was deposited on titanium-coated glass slide by e-beam evaporation, followed by another titanium coating as adhesion layer. A 18 nm-thick SiO₂ spacer layer was deposited on gold backplane by plasma-enhanced-chemical-vapor deposition, under 250° c. by using mixture of SiH₄ and N₂O. Then gold islands were grown by a two-step method consisting of solution-phase seeding and growth: the sample was immersed into a solution of 3 mM HAuCl₄ (aq.). 20 uL NH₄OH was add for every 1 mL of total volume accompanied by rapid shaking for one minute. After two runs of clean water bath to remove unbounded gold ion, the sample was immersed into 1 mM NaBH₄ solution for 1 min and finish the seeding step. For growth steps, the sample was immersed into a 1:1 aqueous solution of HAuCl₄ and NH₂OH in the concentration of 750 uM, and uniformly shaken for 5 min, followed by a 10-min incubation process to complete the growth step. The sample was subjected to clean water bath again and blown dry by N₂. At this point, PCMM structure has been achieved. The whole process is illustrated by FIG. 16, and certain results shown in FIG. 17.

The size of random islands can be controlled by tuning concentration of chloroauric acid (HAuCl4) and hydroxylamine (NH2OH). For larger island size, there will be smaller gap in-between. For example, by tuning the concentration of chloroauric acid (HAuCl4), different metallic islands size (and hence different gap) can be achieved.

It is also possible to the gold island technology to make a nanoimprint mold and then use nanoimprint mode to do the fabrication.

### Systems

Also provided is a system comprising a subject nanosensor, a holder for the nanosensor, an excitation source that induces a light signal from a label (i.e. light emitting label); and a reader (e.g., a photodetector, a CCD camera, a CMOS camera, a spectrometer or an imaging device capable of producing a two dimensional spectral map of a surface of the nanosensor) adapted to read the light signal. As would be apparent, the system may also has electronics, computer system, software, and other hardware that amplify, filter, regulate, control and store the electrical signals from the reader, and control the reader and sample holder positions. The sample holder position can be move in one or all three orthogonal directions to allow the reader to scan the light signal from different locations of the sample.

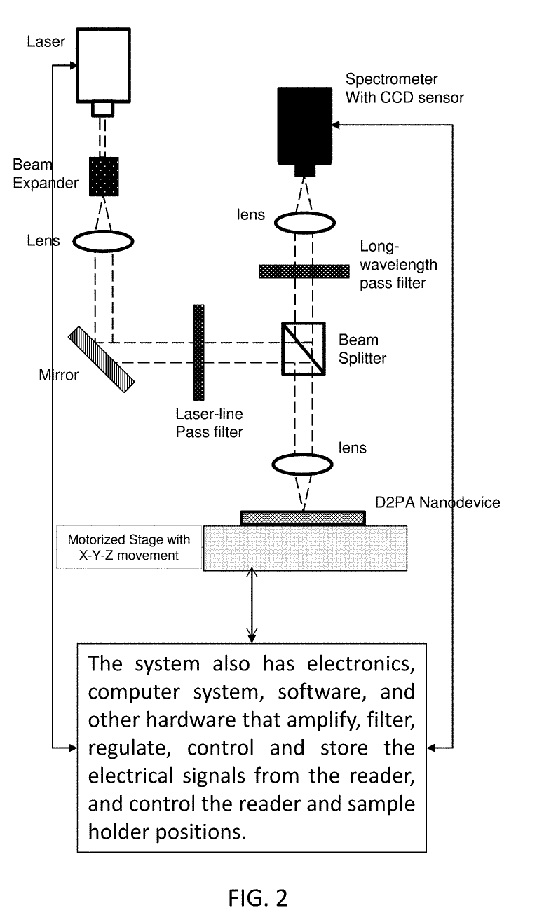

The excitation source may be (a) a light source, e.g., a laser of a wavelength suitable for exciting a particular fluorophore, and a lamp or a light emitting diode with a light filter for wavelength selection; or (b) a power source for providing an electrical current to excite light out of the nanosensor (which may be employed when an electrochemiluminescent label is used). An exemplary system is illustrated in FIG. 2. With reference to FIG. 2, the excitation system may comprise a laser, laser optics (including a beam expander, lens, mirror and a laser line-pass filter), a reader (e.g., a spectrometer with a CCD sensor), further optics (e.g., a long wavelength pass filter, a beam splitter, and a lens), and a holder for the nanosensor. In certain cases, the holder may be on a motorized stage that has an X-Y and Z movement.

In particular cases, laser-line pass filter filters out light whose wavelength is different from the laser, and the long wavelength pass filter will only allow the light emanate from the optically detectable label to pass through. Since different fluorescence labels absorb light in different spectral range, the fluorescence label should be chosen to match its peak absorption wavelength to the laser excitation wavelength in order to achieve optimum quantum efficiency. In many embodiments, the light signal emanating from the fluorescence label on the nanosensors are at a wavelength of at least 20 nm higher than the laser wavelength. Thus the nanosensor's plasmonic resonance should be tuned to cover the fluorescence label's absorption peak, emission peak and laser excitation wavelength. In some embodiments, the excitation and fluorescence wavelength range can be from 100 nm to 20,000 nm. The preferred range is from 300 nm to 1200 nm. The 600-850 nm range is preferable due to low background noise.

It is apparent there are other ways to achieve the functions of light excitation and reading.

As would be apparent from the above, certain nanosensors may be implemented in a multi-well format. In these embodiments, the stage can move moved so that reader can read a light signal from each of the wells of the multi-well plate, independently.

### Assay Methods

The subject nanosensor may be used to detect analytes in a sample. This method may comprise: (a) contacting a sample comprising an analyte with a nanosensor under conditions suitable for specific binding of an analyte in the sample with the capture agent; and (b) reading an optically detectable signal from the nanosensor, wherein the optically detectable signal indicates that the analyte is bound to the capture agent. In the above step (a), before the bonding to the capture agent, the the analyte may be labeled with a light-emitting label or not labeled (also referred as labeled directly or indirectly). In embodiments in which an analyte is no labeled with a light-emitting label before the bonding, the analyte, after the bonding to the capture agent, may be bound to a second capture agent (i.e. detection agent) (e.g., a secondary antibody or another nucleic acid) that is itself optically labeled, labeled secondary capture agent or labeled detection agent, (such process is also referred as indirectly labeling of an analyte). In a sensing using indirectly labeling, the labeled secondary capture agents unbounded to analytes are removed before the above reading step (b). In a sensing using directly labeling, the optical labels unbounded to analytes are removed before the above reading step (b).

In reading the light emitting labels on the assay, an excitation (photo, electro, chemical or combination of them) are applied to light emitting label, and the properties of light including intensity, wavelength, and location are detected.

In certain embodiments, the method comprises attaching a capture agent to the molecular adhesion layer of a subject nanodevice to produce a nanosensor, wherein the attaching is done via a chemical reaction of the capture agent with the capture agent-reactive group in the molecules on the molecular adhesion layer, as described above. Next, the method comprises contacting a sample containing a target-analyte with the nanosensor and the contacting is done under conditions suitable for specific binding and the target-analyte specifically binds to the capture agent. After this step, the method comprises removing any target-analytes that are not bound to the capture agent (e.g., by washing the surface of the nanosensor in binding buffer); Then detection agent conjugated with optical detectable label is added to detect the target-analyte. After removing the detection agent that are not bound to the target-analyte, the nanodevice can then be used, with a reading system, to read a light signal (e.g., light at a wavelength that is in the range of 300 nm to 1200 nm) from detection agent that remain bound to the nanosensor. As would be apparent, the method further comprises labeling the target analytes with a light-emitting label. This can be done either prior to or after the contacting step, i.e., after the analytes are bound to the capture agent. In certain embodiments, analytes are labeled before they are contacted with the nanosensor. In other embodiment, the analytes are labeled after they are bound to the capture agents of the nanosensor. Further, as mentioned above, the analyte may be labeled directly (in which case the analyte may be strongly linked to a light-emitting label at the beginning of the method), or labeled indirectly (i.e., by binding the target analytes to a second capture agent, e.g., a secondary antibody that is labeled or a labeled nucleic acid, that specifically binds to the target analyte and that is linked to a light-emitting label). In some embodiments, the method may comprise blocking the nanosensor prior to the contacting step (b), thereby preventing non-specific binding of the capture agents to non-target analytes.

The suitable conditions for the specific binding and the target-analyte specifically binds to the capture agent, include proper temperature, time, solution pH level, ambient light level, humidity, chemical reagent concentration, antigen-antibody ratio, etc.

In certain embodiments, a nucleic acid capture agent can be used to capture a protein analyte (e.g., a DNA or RNA binding protein). In alternative embodiments, the protein capture agent (e.g., a DNA or RNA binding protein) can be used to capture a nucleic acid analyte.

The sample may be a liquid sample and, in certain embodiments, the sample may be a clinical sample derived from cells, tissues, or bodily fluids. Bodily fluids of interest include but are not limited to, amniotic fluid, aqueous humour, vitreous humour, blood (e.g., whole blood, fractionated blood, plasma, serum, etc.), breast milk, cerebrospinal fluid (CSF), cerumen (earwax), chyle, chime, endolymph, perilymph, feces, gastric acid, gastric juice, lymph, mucus (including nasal drainage and phlegm), pericardial fluid, peritoneal fluid, pleural fluid, pus, rheum, saliva, sebum (skin oil), semen, sputum, sweat, synovial fluid, tears, vomit, urine and exhaled condensate.

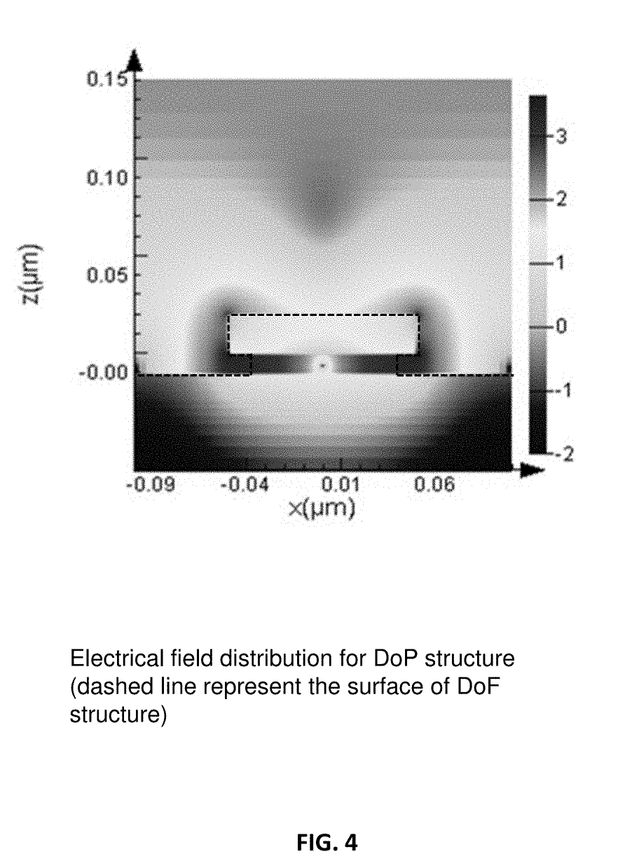

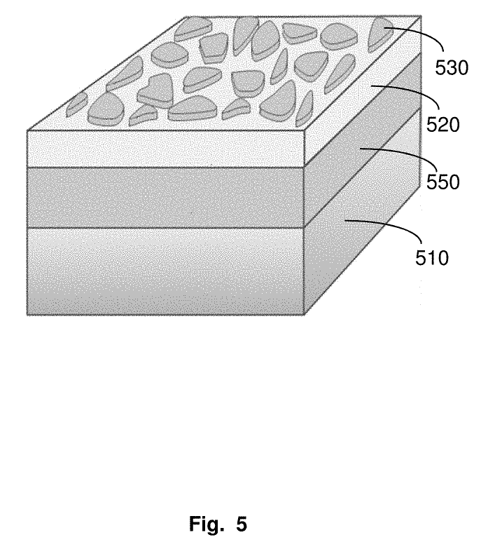

Some of the steps of an assay are shown in FIGS. 7 and 8. General methods for methods for molecular interactions between capture agents and their binding partners (including analytes) are well known in the art (see, e.g., Harlow et al., Antibodies: A Laboratory Manual, First Edition (1988) Cold spring Harbor, N.Y.; Ausubel, et al, Short Protocols in Molecular Biology, 3rd ed., Wiley & Sons, 1995). The methods shown in FIGS. 4 and 5 are exemplary; the methods described in those figures are not the only ways of performing an assay.

Some of the steps of an exemplary antibody binding assay are shown in FIG. 7. In this assay, nanodevice 100 is linked to an antibody in accordance with the methods described above to produce a nanosensor 200 that comprises antibodies 202 that are linked to the molecular adhesion layer of the nanodevice. After nanosensor 200 has been produced, the nanosensor is contacted with a sample containing a target analyte (e.g., a target protein) under conditions suitable for specific binding. The antibodies 202 specifically bind to target analyte 204 in the sample. After unbound analytes have been washed from the nanosensor, the nanosensor is contacted with a secondary antibody 206 that is labeled with a light-emitting label 208 under conditions suitable for specific binding. After unbound secondary antibodies have been removed from the nanosensor, the nanosensor may be read to identify and/or quantify the amount of analyte 204 in the initial sample.

Some of the steps of an exemplary nucleic acid binding assay are shown in FIG. 7. In this assay, nanodevice 100 is linked to a nucleic acid, e.g., an oligonucleotide in accordance with the methods described above to produce a nanosensor 300 that comprises nucleic acid molecules 302 that are linked to the molecular adhesion layer. After nanosensor 200 has been produced, the nanosensor is contacted with a sample containing target nucleic acid 304 under conditions suitable for specific hybridization of target nucleic acid 304 to the nucleic acid capture agents 302. Nucleic acid capture agents 304 specifically binds to target nucleic acid 304 in the sample. After unbound nucleic acids have been washed from the nanosensor, the nanosensor is contacted with a secondary nucleic acid 306 that is labeled with a light-emitting label 308 under conditions for specific hybridization. After unbound secondary nucleic acids have been removed from the nanosensor, the nanosensor may be read to identify and/or quantify the amount of nucleic acid 304 in the initial sample.

One example of an enhanced DNA hybridization assay that can be performed using a subject device is a sandwich hybridization assay. The capture DNA is a single strand DNA functioned with thiol at its 3′-end The detection DNA is a single strand DNA functioned with a fluorescence label e.g., IRDye800CW at its 3′-end. Both the capture and detection DNA has a length of 20 bp. They are synthesized with different sequences to form complementary binding to a targeted DNA at different region. First the capture DNA is immobilized on the D2PA nanodevice's metal surface through sulfur-gold reaction. Then targeted DNA is added to the nanodevice to be captured by the capture DNA. Finally the fluorescence labeled detection DNA is added to the nanodevice to detect the immobilized targeted DNA. After washing off the unbound detection DNA, the fluorescence signal emanate from the nanodevices' surface is measured for the detection and quantification of targeted DNA molecules.

In the embodiments shown in FIGS. 4 and 5, bound analyte can be detected using a secondary capture agent (i.e. the “detection agent”) may be conjugated to a fluorophore or an enzyme that catalyzes the synthesis of a chromogenic compound that can be detected visually or using an imaging system. In one embodiment, horseradish peroxidase (HRP) may be used, which can convert chromogenic substrates (e.g., TMB, DAB, or ABTS) into colored products, or, alternatively, produce a luminescent product when chemiluminescent substrates are used. In particular embodiments, the light signal produced by the label has a wavelength that is in the range of 300 nm to 900 nm). In certain embodiments, the label may be electrochemiluminescent and, as such, a light signal can be produced by supplying a current to the sensor.

In some embodiments, the secondary capture agent (i.e. the detection agent), e.g., the secondary antibody or secondary nucleic acid, may be linked to a fluorophore, e.g., xanthene dyes, e.g. fluorescein and rhodamine dyes, such as fluorescein isothiocyanate (FITC), 6-carboxyfluorescein (commonly known by the abbreviations FAM and F), 6-carboxy-2′,4′,7′,4,7-hexachlorofluorescein (HEX), 6-carboxy-4′, 5′-dichloro-2′, 7′-dimethoxyfluorescein (JOE or J), N,N,N′,N′-tetramethyl-6-carboxyrhodamine (TAMRA or T), 6-carboxy-X-rhodamine (ROX or R), 5-carboxyrhodamine-6G (R6G⁵ or G⁵), 6-carboxyrhodamine-6G (R6G⁶ or G⁶), and rhodamine 110; cyanine dyes, e.g. Cy3, Cy5 and Cy7 dyes; coumarins, e.g umbelliferone; benzimide dyes, e.g. Hoechst 33258; phenanthridine dyes, e.g. Texas Red; ethidium dyes; acridine dyes; carbazole dyes; phenoxazine dyes; porphyrin dyes; polymethine dyes, e.g. cyanine dyes such as Cy3, Cy5, etc; BODIPY dyes and quinoline dyes. Specific fluorophores of interest that are commonly used in subject applications include: Pyrene, Coumarin, Diethylaminocoumarin, FAM, Fluorescein Chlorotriazinyl, Fluorescein, R110, Eosin, JOE, R6G, Tetramethylrhodamine, TAMRA, Lissamine, ROX, Napthofluorescein, Texas Red, Napthofluorescein, Cy3, and Cy5, IRDye800, IRDye800CW, Alexa 790, Dylight 800, etc.

The primary and secondary capture agents should bind to the target analyte with highly-specific affinity. However, the primary and secondary capture agents cannot be the molecule because they need to bind to different sites in the antigen. One example is the anti-human beta amyloid capture antibody 6E10 and detection G210, in which case 6E10 binds only to the 10^{th} amine site on human beta amyloids peptide while G210 binds only to the 40^{th} amine site. Capture agent and secondary capture agent do not react to each other. Another example uses rabbit anti-human IgG as capture antibody and donkey anti-human IgG as detection antibody. Since the capture and detection agents are derived from different host species, they do not react with each other.

Methods for labeling proteins, e.g., secondary antibodies, and nucleic acids with fluorophores are well known in the art. Chemiluminescent labels include acridinium esters and sulfonamides, luminol and isoluminol; electrochemiluminescent labels include ruthenium (II) chelates, and others are known.

### Applications

The subject methods and compositions find use in a variety applications, where such applications are generally analyte detection applications in which the presence of a particular analyte in a given sample is detected at least qualitatively, if not quantitatively. Protocols for carrying out analyte detection assays are well known to those of skill in the art and need not be described in great detail here. Generally, the sample suspected of comprising an analyte of interest is contacted with the surface of a subject nanosensor under conditions sufficient for the analyte to bind to its respective capture agent that is tethered to the sensor. The capture agent has highly specific affinity for the targeted molecules of interest. This affinity can be antigen-antibody reaction where antibodies bind to specific epitope on the antigen, or a DNA/RNA or DNA/RNA hybridization reaction that is sequence-specific between two or more complementary strands of nucleic acids. Thus, if the analyte of interest is present in the sample, it likely binds to the sensor at the site of the capture agent and a complex is formed on the sensor surface. Namely, the captured analytes are immobilized at the sensor surface. After removing the unbounded analytes, the presence of this binding complex on the surface of the sensor (i.e. the immobilized analytes of interest) is then detected, e.g., using a labeled secondary capture agent.

Specific analyte detection applications of interest include hybridization assays in which the nucleic acid capture agents are employed and protein binding assays in which polypeptides, e.g., antibodies, are employed. In these assays, a sample is first prepared and following sample preparation, the sample is contacted with a subject nanosensor under specific binding conditions, whereby complexes are formed between target nucleic acids or polypeptides (or other molecules) that are complementary to capture agents attached to the sensor surface.

In one embodiment, the capture oligonucleotide is synthesized single strand DNA of 20-100 bases length, that is thiolated at one end. These molecules are are immobilized on the nanodevices' surface to capture the targeted single-strand DNA (which may be at least 50 bp length) that has a sequence that is complementary to the immobilized capture DNA. After the hybridization reaction, a detection single strand DNA (which can be of 20-100 bp in length) whose sequence are complementary to the targeted DNA's unoccupied nucleic acid is added to hybridize with the target. The detection DNA has its one end conjugated to a fluorescence label, whose emission wavelength are within the plasmonic resonance of the nanodevice. Therefore by detecting the fluorescence emission emanate from the nanodevices' surface, the targeted single strand DNA can be accurately detected and quantified. The length for capture and detection DNA determine the melting temperature (nucleotide strands will separate above melting temperature), the extent of misparing (the longer the strand, the lower the misparing). One of the concerns of choosing the length for complementary binding depends on the needs to minimize misparing while keeping the melting temperature as high as possible. In addition, the total length of the hybridization length is determined in order to achieve optimum signal amplification.

A subject sensor may be employed in a method of diagnosing a disease or condition, comprising: (a) obtaining a liquid sample from a patient suspected of having the disease or condition, (b) contacting the sample with a subject nanosensor, wherein the capture agent of the nanosensor specifically binds to a biomarker for the disease and wherein the contacting is done under conditions suitable for specific binding of the biomarker with the capture agent; (c) removing any biomarker that is not bound to the capture agent; and (d) reading a light signal from biomarker that remain bound to the nanosensor, wherein a light signal indicates that the patient has the disease or condition, wherein the method further comprises labeling the biomarker with a light-emitting label, either prior to or after it is bound to the capture agent. As will be described in greater detail below, the patient may suspected of having cancer and the antibody binds to a cancer biomarker. In other embodiments, the patient is suspected of having a neurological disorder and the antibody binds to a biomarker for the neurological disorder.

The applications of the subject sensor include, but not limited to, (a) the detection, purification and quantification of chemical compounds or biomolecules that correlates with the stage of certain diseases, e.g., infectious and parasitic disease, injuries, cardiovascular disease, cancer, mental disorders, neuropsychiatric disorders and organic diseases, e.g., pulmonary diseases, renal diseases, (b) the detection, purification and quantification of microorganism, e.g., virus, fungus and bacteria from environment, e.g., water, soil, or biological samples, e.g., tissues, bodily fluids, (c) the detection, quantification of chemical compounds or biological samples that pose hazard to food safety or national security, e.g. toxic waste, anthrax, (d) quantification of vital parameters in medical or physiological monitor, e.g., glucose, blood oxygen level, total blood count, (e) the detection and quantification of specific DNA or RNA from biosamples, e.g., cells, viruses, bodily fluids, (f) the sequencing and comparing of genetic sequences in DNA in the chromosomes and mitochondria for genome analysis or (g) to detect reaction products, e.g., during synthesis or purification of pharmaceuticals.

The detection can be carried out in various sample matrix, such as cells, tissues, bodily fluids, and stool. Bodily fluids of interest include but are not limited to, amniotic fluid, aqueous humour, vitreous humour, blood (e.g., whole blood, fractionated blood, plasma, serum, etc.), breast milk, cerebrospinal fluid (CSF), cerumen (earwax), chyle, chime, endolymph, perilymph, feces, gastric acid, gastric juice, lymph, mucus (including nasal drainage and phlegm), pericardial fluid, peritoneal fluid, pleural fluid, pus, rheum, saliva, sebum (skin oil), semen, sputum, sweat, synovial fluid, tears, vomit, urine and exhaled condensate.

In some embodiments, a subject biosensor can be used diagnose a pathogen infection by detecting a target nucleic acid from a pathogen in a sample. The target nucleic acid may be, for example, from a virus that is selected from the group comprising human immunodeficiency virus 1 and 2 (HIV-1 and HIV-2), human T-cell leukaemia virus and 2 (HTLV-1 and HTLV-2), respiratory syncytial virus (RSV), adenovirus, hepatitis B virus (HBV), hepatitis C virus (HCV), Epstein-Barr virus (EBV), human papillomavirus (HPV), varicella zoster virus (VZV), cytomegalovirus (CMV), herpes-simplex virus 1 and 2 (HSV-1 and HSV-2), human herpesvirus 8 (HHV-8, also known as Kaposi sarcoma herpesvirus) and flaviviruses, including yellow fever virus, dengue virus, Japanese encephalitis virus and West Nile virus. The present invention is not, however, limited to the detection of DNA sequences from the aforementioned viruses, but can be applied without any problem to other pathogens important in veterinary and/or human medicine.

Human papillomaviruses (HPV) are further subdivided on the basis of their DNA sequence homology into more than 70 different types. These types cause different diseases. HPV types 1, 2, 3, 4, 7, 10 and 26-29 cause benign warts. HPV types 5, 8, 9, 12, 14, 15, 17 and 19-25 and 46-50 cause lesions in patients with a weakened immune system. Types 6, 11, 34, 39, 41-44 and 51-55 cause benign acuminate warts on the mucosae of the genital region and of the respiratory tract. HPV types 16 and 18 are of special medical interest, as they cause epithelial dysplasias of the genital mucosa and are associated with a high proportion of the invasive carcinomas of the cervix, vagina, vulva and anal canal. Integration of the DNA of the human papillomavirus is considered to be decisive in the carcinogenesis of cervical cancer. Human papillomaviruses can be detected for example from the DNA sequence of their capsid proteins L1 and L2. Accordingly, the method of the present invention is especially suitable for the detection of DNA sequences of HPV types 16 and/or 18 in tissue samples, for assessing the risk of development of carcinoma.

In some cases, the nanosensor may be employed to detect a biomarker that is present at a low concentration. For example, the nanosensor may be used to detect cancer antigens in a readily accessible bodily fluids (e.g., blood, saliva, urine, tears, etc.), to detect biomarkers for tissue-specific diseases in a readily accessible bodily fluid (e.g., a biomarkers for a neurological disorder (e.g., Alzheimer's antigens)), to detect infections (particularly detection of low titer latent viruses, e.g., HIV), to detect fetal antigens in maternal blood, and for detection of exogenous compounds (e.g., drugs or pollutants) in a subject's bloodstream, for example.

The following table provides a list of protein biomarkers that can be detected using the subject nanosensor (when used in conjunction with an appropriate monoclonal antibody), and their associated diseases. One potential source of the biomarker (e.g., “CSF”; cerebrospinal fluid) is also indicated in the table. In many cases, the subject biosensor can detect those biomarkers in a different bodily fluid to that indicated. For example, biomarkers that are found in CSF can be identified in urine, blood or saliva, for example.

| Marker | disease |
|---|---|
| Aβ42, amyloid beta-protein (CSF) | Alzheimer's disease. |
| fetuin-A (CSF) | multiple sclerosis. |
| tau (CSF) | niemann-pick type C. |
| secretogranin II (CSF) | bipolar disorder. |
| prion protein (CSF) | Alzheimer disease, prion disease |
| Cytokines (CSF) | HIV-associated neurocognitive disorders |
| Alpha-synuclein (CSF) | parkinsonian disorders (neuordegenerative |
| | disorders) |
| tau protein (CSF) | parkinsonian disorders |
| neurofilament light chain (CSF) | axonal degeneration |
| parkin (CSF) | neuordegenerative disorders |
| PTEN induced putative kinase 1 (CSF) | neuordegenerative disorders |
| DJ-1 (CSF) | neuordegenerative disorders |
| leucine-rich repeat kinase 2 (CSF) | neuordegenerative disorders |
| mutated ATP13A2 (CSF) | Kufor-Rakeb disease |
| Apo H (CSF) | parkinson disease (PD) |
| ceruloplasmin (CSF) | PD |
| Peroxisome proliferator-activated receptor | PD |
| gamma coactivator-1 alpha (PGC-1α)(CSF) | |
| transthyretin (CSF) | CSF rhinorrhea (nasal surgery samples) |
| Vitamin D-binding Protein (CSF) | Multiple Sclerosis Progression |
| proapoptotic kinase R (PKR) and its | AD |
| phosphorylated PKR (pPKR) (CSF) | |
| CXCL13 (CSF) | multiple sclerosis |
| IL-12p40, CXCL13 and IL-8 (CSF) | intrathecal inflammation |
| Dkk-3 (semen) | prostate cancer |
| p14 endocan fragment (blood) | Sepsis: Endocan, specifically secreted by |
| | activated-pulmonary vascular endothelial |
| | cells, is thought to play a key role in the |
| | control of the lung inflammatory reaction. |
| Serum (blood) | neuromyelitis optica |
| ACE2 (blood) | cardiovascular disease |
| autoantibody to CD25 (blood) | early diagnosis of esophageal squamous cell |
| | carcinoma |
| hTERT (blood) | lung cancer |
| CAI25 (MUC 16) (blood) | lung cancer |
| VEGF (blood) | lung cancer |
| sIL-2 (blood) | lung cancer |
| Osteopontin (blood) | lung cancer |
| Human epididymis protein 4 (HE4) (blood) | ovarian cancer |
| Alpha-Fetal Protein (blood) | pregnancy |
| Albumin (urine) | diabetics |
| albumin (urine) uria | albuminuria |
| microalbuminuria | kidney leaks |
| AFP (urine) | mirror fetal AFP levels |
| neutrophil gelatinase-associated lipocalin (NGAL) | Acute kidney injury |
| (urine) | |
| interleukin 18 (IL-18) (urine) | Acute kidney injury |
| Kidney Injury Molecule -1 (KIM-1) (urine) | Acute kidney injury |
| Liver Fatty Acid Binding Protein (L-FABP) (urine) | Acute kidney injury |
| LMP1 (saliva) | Epstein-Barr virus oncoprotein |
| | (nasopharyngeal carcinomas) |
| BARF1 (saliva) | Epstein-Barr virus oncoprotein |
| | (nasopharyngeal carcinomas) |
| IL-8 (saliva) | oral cancer biomarker |
| carcinoembryonic antigen (CEA) (saliva) | oral or salivary malignant tumors |
| BRAF, CCNI, EGRF, FGF19, FRS2, GREB1, and | Lung cancer |
| LZTS1 (saliva) | |
| alpha-amylase (saliva) | cardiovascular disease |
| carcinoembryonic antigen (saliva) | Malignant tumors of the oral cavity |
| CA 125 (saliva) | Ovarian cancer |
| IL8 (saliva) | spinalcellular carcinoma. |
| thioredoxin (saliva) | spinalcellular carcinoma. |
| beta-2 microglobulin levels - monitor activity of | HIV |
| the virus (saliva) | |
| tumor necrosis factor-alpha receptors - monitor | HIV |
| activity of the virus (saliva) | |
| CA15-3 (saliva) | breast cancer |

As noted above, a subject nanosensor can be used to detect nucleic acid in a sample. A subject nanosensor may be employed in a variety of drug discovery and research applications in addition to the diagnostic applications described above. For example, a subject nanosensor may be employed in a variety of applications that include, but are not limited to, diagnosis or monitoring of a disease or condition (where the presence of an nucleic acid provides a biomarker for the disease or condition), discovery of drug targets (where, e.g., an nucleic acid is differentially expressed in a disease or condition and may be targeted for drug therapy), drug screening (where the effects of a drug are monitored by assessing the level of an nucleic acid), determining drug susceptibility (where drug susceptibility is associated with a particular profile of nucleic acids) and basic research (where is it desirable to identify the presence a nucleic acid in a sample, or, in certain embodiments, the relative levels of a particular nucleic acids in two or more samples).

In certain embodiments, relative levels of nucleic acids in two or more different nucleic acid samples may be obtained using the above methods, and compared. In these embodiments, the results obtained from the above-described methods are usually normalized to the total amount of nucleic acids in the sample (e.g., constitutive RNAs), and compared. This may be done by comparing ratios, or by any other means. In particular embodiments, the nucleic acid profiles of two or more different samples may be compared to identify nucleic acids that are associated with a particular disease or condition.

In some examples, the different samples may consist of an “experimental” sample, i.e., a sample of interest, and a “control” sample to which the experimental sample may be compared. In many embodiments, the different samples are pairs of cell types or fractions thereof, one cell type being a cell type of interest, e.g., an abnormal cell, and the other a control, e.g., normal, cell. If two fractions of cells are compared, the fractions are usually the same fraction from each of the two cells. In certain embodiments, however, two fractions of the same cell may be compared. Exemplary cell type pairs include, for example, cells isolated from a tissue biopsy (e.g., from a tissue having a disease such as colon, breast, prostate, lung, skin cancer, or infected with a pathogen etc.) and normal cells from the same tissue, usually from the same patient; cells grown in tissue culture that are immortal (e.g., cells with a proliferative mutation or an immortalizing transgene), infected with a pathogen, or treated (e.g., with environmental or chemical agents such as peptides, hormones, altered temperature, growth condition, physical stress, cellular transformation, etc.), and a normal cell (e.g., a cell that is otherwise identical to the experimental cell except that it is not immortal, infected, or treated, etc.); a cell isolated from a mammal with a cancer, a disease, a geriatric mammal, or a mammal exposed to a condition, and a cell from a mammal of the same species, preferably from the same family, that is healthy or young; and differentiated cells and non-differentiated cells from the same mammal (e.g., one cell being the progenitor of the other in a mammal, for example). In one embodiment, cells of different types, e.g., neuronal and non-neuronal cells, or cells of different status (e.g., before and after a stimulus on the cells) may be employed. In another embodiment of the invention, the experimental material is cells susceptible to infection by a pathogen such as a virus, e.g., human immunodeficiency virus (HIV), etc., and the control material is cells resistant to infection by the pathogen. In another embodiment of the invention, the sample pair is represented by undifferentiated cells, e.g., stem cells, and differentiated cells.

Although the foregoing embodiments have been described in some detail by way of illustration and example for purposes of clarity of understanding, it is readily apparent to those of ordinary skill in the art in light of the above teachings that certain changes and modifications can be made thereto without departing from the spirit or scope of the appended claims.

### Examples

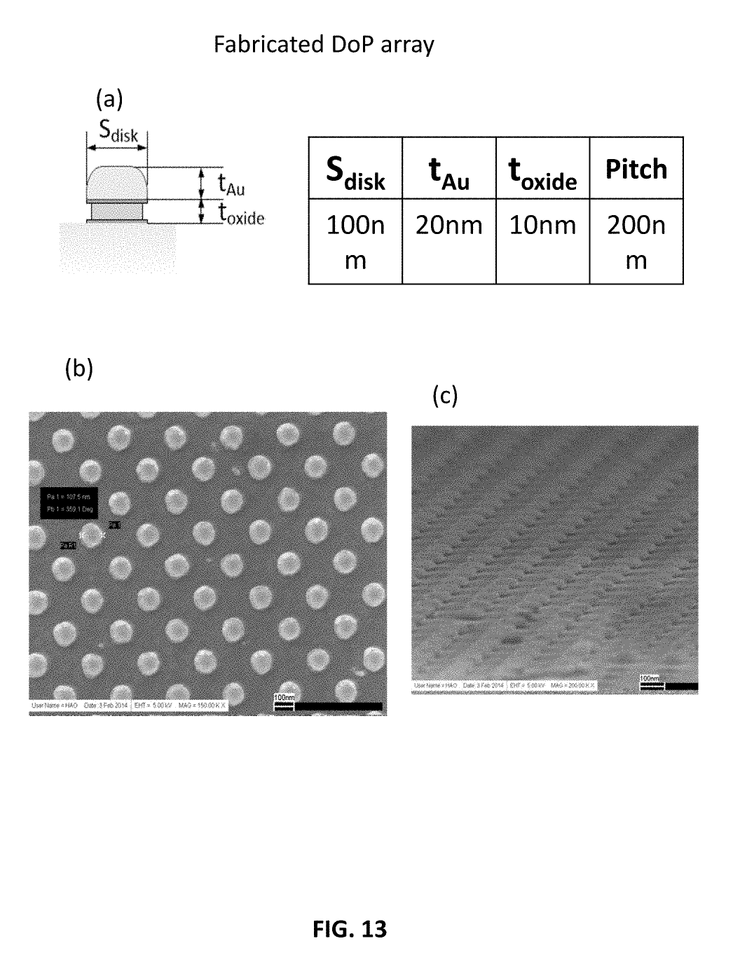

Various nanosensors have been fabricated. FIG. 13 shows fabrication result of one embodiment of DoP structure. (a) parameter used in the fabrication, including disk size s_{disk}, disk height t_{Au}, and pillar height t_{oxide}. (b) top-view and (c) tilted-view of fabricated DoP structure. The fabrication process comprises: (a) a 200 nm SiO2 layer is thermally grown on silicon and 40 nm gold back film is evaporated; (b) nanoimprint is performed by using a 200 nm-pitch pillar mold; (c) after residual resist etching, 10 nm SiO2 layer and 20 nm gold layer are evaporated successively with Ti as adhesive layer; (d) resist lift-off, and (e) an etch in a diluted buffered oxide etching (BOE) to shrinks the size of SiO2 pillars, creating the vertical nano-gap, allowing the labeled molecule to be captured and hence further enhancing the sensing.

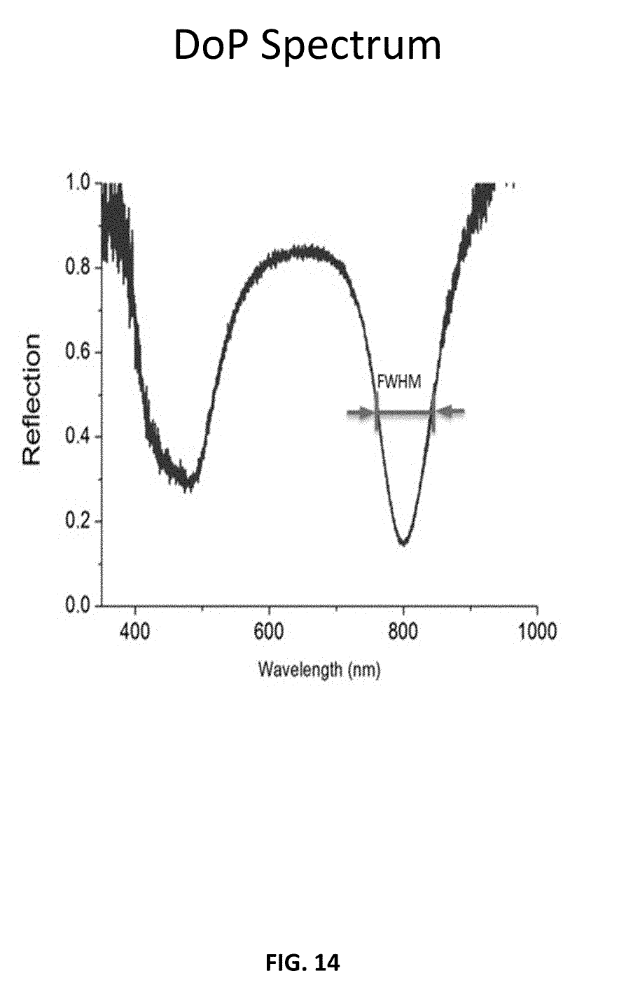

FIG. 14 shows reflection spectrum of a DoP sample, whose resonance peak has been tune to 800 nm and peak width of 80 nm. By deliberately tuning disk and pillar size, resonance peak at 650 nm-850 nm can be achieved.

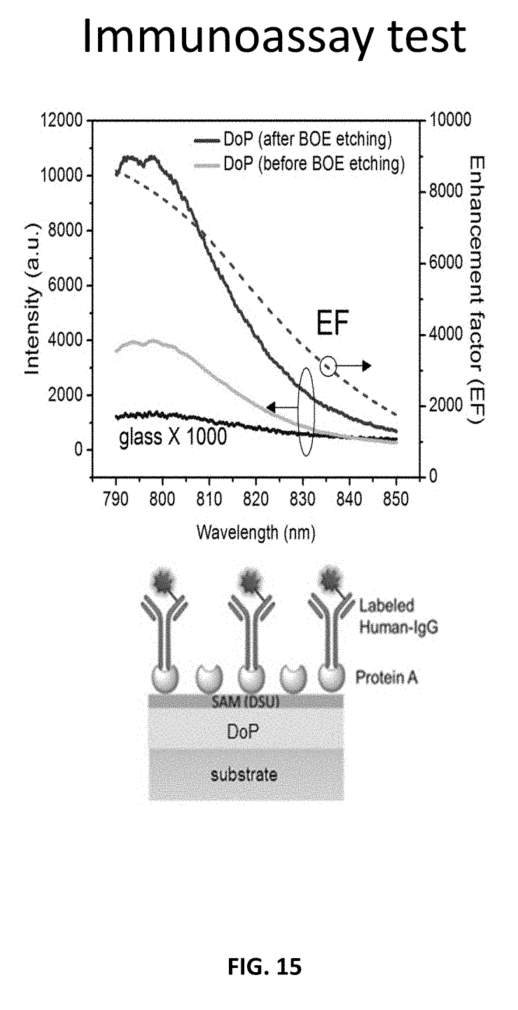

FIG. 15 shows immunoassay test on glass (blue curve, reference, magnified by 1000 times), DoP (green curve) and DoP with pillar shrinking (red curve). Enhancement factor from DoP with pillar shrinking can be as high as 6500 on average.

FIG. 16 shows a flow chart for fabrication.

FIG. 17 shows SEM picture of nano-islands on continuous dielectric film. (a) top-view; (b) tilted-view.

1. A nanosensor for sensing an analyte, comprising:
(a) a substrate;
(b) a signal amplification layer comprising:
(i) a substantially continuous metallic backplane on the substrate;
(ii) one or a plurality of pillars extending from the metallic backplane or from the substrate through holes in the backplane; and
(iii) a metallic disk on top of the pillar, wherein at least one portion of the edge of the disk is separated from the metallic backplane; and
(c) a capture agent that specifically binds to the analyte, wherein the capture agent is linked to the surface of the signal amplification layer;
wherein said nanosensor amplifies a light signal from an analyte, when said analyte is bound to the capture agent.

2. The nanosensor of claim 1, wherein the capture agent is linked to the amplification layer surface by a molecular adhesion layer that covers at least a part of the metal disc and/or the metallic backplane.

3. The nanosensor of claim 1, wherein the dimensions of the metallic disk, the pillars, the holes, and the separation are all smaller than the wavelength of the signal.

4. The nanosensor of claim 1, wherein the pillars are only on the top surface of the metallic backplane.

5. The nanosensor of claim 1, wherein the pillars are only on the top surface of the substrate and through the holes.

6. The nanosensor of claim 1, wherein the at least one portion of the edge of the disk and the metallic backplane are separated by less than 30 nm.

7. The nanosensor of claim 1, wherein the at least one portion of the edge of the disk and the metallic backplane are separated by less than 15 nm.

8. The nanosensor of claim 1, wherein the pillars are periodic or aperiodic.

9. The nanosensor of claim 1, wherein said pillar comprises a dielectric or semiconductor material selected from the group consisting of polymers, silicon-dioxide, silicon-nitride, hafnium oxide, aluminum oxide, silicon, gallium arsenide, and gallium nitride.

10. The nanosensor of claim 1, wherein the metallic material is selected from the group consisting of gold, silver, copper, aluminum, alloys thereof, and combinations thereof.

11. The nanosensor of claim 1, wherein the top of said pillar has a shape selected from the group of shapes consisting of round, polygonal, pyramidal, elliptical, elongated bar shaped, or any combination thereof.

12. The nanosensor of claim 1, wherein the analyte is selected from the group consisting of a protein, a peptide, a DNA, an RNA, a nucleic acid, a small molecule, a cell, and a nanoparticle with different shapes.

13. The nanosensor of claim 1, wherein the signals are luminescence signals selected from the group consisting of fluorescence, electroluminescence, chemiluminescence, and electrochemiluminescence signals.

14. The nanosensor of claim 1, wherein the signals are Raman scattering signals.

15. The nanosensor of claim 1, wherein light signal from an analyte is from a directly labeled analyte or a detection agent that is bound to the analyte.

16. The nanosensor of claim 1, wherein said molecular adhesion layer is a self-assembled monolayer (SAM), wherein each molecule of the SAM comprises three parts: (i) a head group that has specific affinity to the metal surfaces of the nanodevice, (ii) a terminal group that specific affinity to the capture agent, and (iii) a linker that links the head group and terminal group, wherein the length of the linker determines the average spacing between the metal surfaces and an attached capture agent can affects light amplification of the nanodevice.

17. The nanosensor of claim 1, wherein the nanosensor is part of a plate or inside microfluidic channel.

18. The nanosensor of claim 1, wherein the nanosensor has a lateral dimension from 1 micron to 100 centimeter.

19. The nanosensor of claim 1, wherein the at least one portion of the edge of the disk and the metallic backplane are separated by less than 10 nm.

20. A system comprising:
(a) a nanosensor of claim 1;
(b) a holder for said nano sensor;
(c) an excitation source that induces a light signal from a label; and
(d) a reader adapted to read said light signal.

21-30. (canceled)
